(19) United States
(12) Patent Application Publication
(10) Pub. No.: US 2025/0047115 A1
(43) Pub. Date: Feb. 6, 2025

(54) WIRELESS CHARGING APPARATUS FOR WEARABLE RING DEVICE WITH ENHANCED INTERACTIVE USER INTERFACE

(71) Applicant: CONZUMEX INDUSTRIES PRIVATE LIMITED, Bangalore (IN)

(72) Inventors: Prathyusha Kamarajugadda, Bangalore (IN); KLN SAI PRASANTH, Bangalore (IN)

(21) Appl. No.: 18/793,131

(22) Filed: Aug. 2, 2024

(30) Foreign Application Priority Data
Aug. 4, 2023 (IN) 202341052515
Jul. 9, 2024 (IN) 202441052509

(51) Int. Cl. H02J 7/00; H02J 50/10

(52) U.S. Cl. CPC H02J 7/0049; H02J 7/0044; H02J 50/10

(57) ABSTRACT

This patent application relates to wireless charging apparatus for charging wearable ring device. The wireless charging apparatus comprises cover assembly that and base assembly connected to cover assembly. Base assembly comprises first set of visual indicators, charging area, proximity sensor, and microcontroller. Charging area is provided in internal region in which wearable ring device is placed for charging. The proximity sensor detects presence of wearable ring device within charging area. Also, microcontroller receives signal indicating whether wearable ring device is present within charging area. Further, when signal indicates that wearable ring device is present, microcontroller performs NFC-based charging operation of wearable ring device. Further, displays first unique pattern using first set of visual indicators and plays first custom sound. Further, when signal indicates that wearable ring device is not present within charging area, microcontroller displays second unique pattern using first set of visual indicators and plays second custom sound.

### CROSS-REFERENCE TO RELATED APPLICATIONS

The present application claims priority from Indian Provisional Application Numbers 202341052515 filed on 4 August 2023 and 202441052509 filed on 9 July 2024, all of which are incorporated herein by reference.

### FIELD OF THE INVENTION

The proposed embodiments relate to a wireless charging case. More particularly, the present disclosure relates to a wireless charging apparatus for wearable ring device with enhanced interactive user interface.

### BACKGROUND OF INVENTION

The wearable technology has become increasingly popular in recent years, with many people opting to use wearable ring devices to perform various operations such as monitor their vital signs and ambient data, do normal phone activities such as calling, messaging, etc. However, one of the biggest challenges with wearable ring devices is their power consumption. These devices require a significant amount of power to perform their operations, and they are typically charged through wired charging cables. This can be inconvenient for users, as they must carry the charging cables with them at all times. Additionally, there are no efficient charging solutions available specifically for wearable ring devices.

To address these issues, researchers and developers have been working on new charging solutions that are more user-friendly and efficient. One such solution is wireless charging. This technique allows the charging of the smart ring by applying it to a charging source, such as a charger. A charger cable is directly applied to a charging interface provided on the wearable device to charge the wearable ring device. However, wireless charging cases have their own set of disadvantages. For instance, some conventional techniques only provide a common visual indicator to indicate the charging rate, which can be difficult for users to interpret. Particularly, users will not be able to determine the amount of charging done for the wearable ring devices once placed within the charging case. Additionally, conventional techniques for charging cases include electrode-based charging, which will only be done when the electrodes placed on the wearable device are in contact with the electrodes placed on the charging case.

To overcome these challenges, it is desired to provide a user-friendly and multi-functional charging source for wearable ring devices. This charging source should be capable of wirelessly charging the device while also providing clear indications of the charging rate and other functions. Additionally, the charging source should be capable of receiving external power through a USB port to charge the internal battery or the device. By addressing these issues, a more efficient and user-friendly charging source for wearable ring devices can be provided, making it easier for users to keep their devices charged and ready to use at all times.

This gap in the current system underscores the need for improved solutions to address these disadvantages, issues, or other shortcomings, or at least to provide a useful alternative.

### OBJECT OF INVENTION

The principal object of the embodiments herein is to provide a wireless charging apparatus for wearable ring device with enhanced interactive user interface.

Another object of the invention is to provide a portable wireless charging apparatus which is designed to be compact and lightweight, making it easy to carry around. This makes it ideal for people who are always on the move and need to charge their wearable ring device frequently.

Yet another object of the invention is to provide a portable wireless charging case with NFC based wireless charging capability to charge the wearable ring device, when the wearable ring device is placed inside the portable wireless charging case. The charging case is also designed to be durable and long-lasting, ensuring that it provides reliable charging for an extended period. With the portable wireless charging case with NFC based wireless charging capability, users can enjoy the benefits of their wearable ring device without worrying about battery life.

Yet another object of the invention is to provide a magic glyph interface on the wireless charging apparatus to indicate the various charging levels of both the wireless charging apparatus and the wearable ring device. The magic glyph interface includes a series of symbols that light up to indicate the charging level of the devices which makes it easy to use and understand.

Yet another object of the invention is to provide a multi-functionality interaction mode to perform various operations using the wireless charging apparatus.

Yet another object of the invention is to provide an audio output device on the portable wireless charging apparatus that plays different patterns of custom sound to indicate the various operations of the wireless charging apparatus.

Yet another object of the invention is to provide a power input port on the portable wireless charging apparatus that can be used to power the wireless charging apparatus through an external power supply.

Yet another object of the invention is to provide a user interactive wireless charging apparatus that can be used to share user activity data between the mobile device and the wireless charging apparatus and the wearable ring device.

Yet another object of the invention is to provide the portable wireless charging apparatus that determines a feasible wake-up time based on the sleep stage data of the user.

### BRIEF SUMMARY OF THE INVENTION

In one aspect, the objectives are achieved by providing a wireless charging apparatus for charging a wearable ring device. The wireless charging apparatus comprises a cover assembly and a base assembly. The base assembly is connected to the cover assembly. Further, the base assembly comprises a first set of visual indicators embedded in an external surface of the base assembly. The base assembly comprises a charging area, a proximity sensor, and a microcontroller. The charging area is provided in an internal region of the base assembly in which the wearable ring device is placed for charging. The proximity sensor is configured to detect a presence of the wearable ring device within the charging area. The microcontroller is connected to the first set of visual indicators. Also, the microcontroller receives a signal indicating whether the wearable ring device is present within the charging area from the proximity sensor. Further, when the signal indicates that the wearable ring device is present within the charging area, the microcontroller performs a NFC-based charging operation of the wearable ring device. Further, displays a first unique pattern of a plurality of unique patterns using the first set of visual indicators and plays a first custom sound corresponding to the first unique pattern. The first unique pattern indicates variations in a charging status of the wearable ring device. Further, when the signal indicates that the wearable ring device is not present within the charging area, the microcontroller displays a second unique pattern from the plurality of unique patterns using the first set of visual indicators and plays a second custom sound corresponding to the second unique pattern. The second unique pattern indicates variations in a charging status of the wireless charging apparatus.

In an embodiment, the external surface of the base assembly comprises a first visual area displaying the first unique pattern indicating the variations in charging status of the wearable ring device, and a second visual area displaying the second unique pattern indicating the variations in charging status of the wireless charging apparatus.

In an embodiment, the first set of visual indicators comprises light-emitting elements arranged in the first visual area in a circular or semicircular configuration to form the variations in the charging status of the wearable ring device, and wherein the second visual area is in proximity to the first visual area.

In an embodiment, each unique pattern of the plurality of unique patterns are programmed to change at least one of colour, blink, and animate in various sequences to convey the variations in the charging status of at least one of the wearable ring device and the wireless charging apparatus.

In an embodiment, the base assembly comprises a visually permeable region provided in an external surface of the base assembly and a second set of visual indicators. The second set of visual indicators are embedded in the visually permeable region provided in the external surface of the base assembly. The second set of visual indicators are configured to visually display a third unique patterns to a user of the wireless charging apparatus and play a third custom sound corresponding to the third unique pattern. Further, the microcontroller is connected to the second set of visual indicators, and the microcontroller is configured to determine whether an application configuration is met, and displaying a fourth unique pattern from the plurality of unique patterns on the visually permeable region of the base assembly using second set of visual indicators and playing a fourth custom sound corresponding to the fourth unique pattern. The fourth unique pattern indicates a status of the application configuration to the user.

In an embodiment, the second set of visual indicators includes light-emitting elements arranged at periphery of the visually permeable region of the base assembly.

In an embodiment, the visually permeable region is made of a transparent or semi-transparent material.

In an embodiment, the application configuration corresponds to at least one of an alarm application, a wind down application, an activation of a “Find my” function in an associated mobile device to locate the wireless charging apparatus, and an activation of a lost mode in the associated mobile device to prevent the wireless charging apparatus from connecting to any other device when misplaced.

In an embodiment, the microcontroller is configured to receive the signal from the proximity sensor, when the wearable ring device is worn on a finger of a user. Further, the microcontroller determines whether the wearable ring device is positioned correctly in the charging area of the wireless charging apparatus. Further, the microcontroller displays a fifth unique pattern from the plurality of unique patterns using the first set of visual indicators and play a fifth custom sound corresponding to the fifth unique pattern. The fifth unique pattern indicates a placement status of the wearable ring device in the charging area of the wireless charging apparatus based on the determination.

In an embodiment, the wireless charging apparatus includes a hall effect sensor configured to detect opening and closing of the cover assembly and sends a signal about opening and closing of the cover assembly to the microcontroller. A user interface element to receive input from user to perform one or more operations when an input is received from the user for a defined period of time. An audio output device configured to play custom sound based on the one or more operations performed by the wireless charging apparatus. A power input port configured to receive voltage signals from external power supply to charge the wireless charging apparatus; An antenna configured to generate an electromagnetic field that is used to charge the wearable ring device and induce current within the antenna of the wearable ring device, and charge the wearable ring device through the antenna of the wearable ring device. A power management controller configured to supply power to the battery, the charging controller, visual indicators, proximity sensor and the hall effect sensor. A charging controller configured to charge the wearable ring device when the wearable ring device is placed within the charging area. A battery configured to supply power to the charging controller for charging wearable ring device, and a memory configured to store information about at least one of the opening and closing of the cover assembly, whether the wearable ring device is placed within the charging area, the plurality of unique patterns, and application configurations.

In an embodiment, the microcontroller is configured to receive an input from the user on the user interface element for the defined period of time. Further, the microcontroller activates a breathing mode within the wireless charging apparatus based on the input received from the user for the defined period of the time. Further, the microcontroller displays a sixth unique pattern from the plurality of unique patterns using the first set of visual indicators when the wireless charging apparatus is in the breathing mode and play a sixth custom sound corresponding to the sixth unique pattern. The sixth unique pattern indicates at least one of a breathe-in, breathe-out, and breathe-hold cues to the user.

In an embodiment, the microcontroller is configured to determine a status of Bluetooth paring process between the wireless charging apparatus and the wearable ring device. Further, the microcontroller displays a seventh unique pattern from the plurality of unique patterns using the first set of visual indicators and play a seventh custom sound corresponding to the seventh unique pattern. The seventh unique pattern indicates the status of Bluetooth paring process between the wireless charging apparatus and the wearable ring device.

In an embodiment, to perform the NFC-based charging operation the wearable ring device, the wireless charging apparatus receives signal by the antenna from the charging controller to charge the wearable ring device. Further, the wireless charging apparatus generates an electromagnetic field that induces current within the antenna of the wearable ring device using the charging controller. Further, the wireless charging apparatus performs the NFC-based charging operation of the wearable ring device based on the generated electromagnetic field.

In an embodiment, the microcontroller is configured to receive an indication about the input from the user interface element through first connection to perform the one or more operations. Further the microcontroller receives an indication of the correct placement or incorrect placement of the wearable ring device within the charging area from the proximity sensor through second connections. Further, the microcontroller receives an indication of the opening or closing of the cover assembly from the hall effect sensor through third connection. Further, the microcontroller receives input voltage from the power management controller to control the operations of the wireless charging apparatus. Further, the microcontroller sends the control signals to the charging controller through fourth connection to charge the wearable ring device, when the indication of the correct placement of the wearable ring device within the charging area is received from the proximity sensor. Further, the microcontroller sends control signals to the visual indicators through fifth connection to emit the light in a unique patterns based on the inputs received from the user interface element. Further, the microcontroller sends the control signals to the audio output device through sixth connection to play a custom sound corresponding to a unique pattern based on the inputs received from the user interface element.

In an embodiment, the charging controller is configured to receive control signals from the microcontroller through fourth connection to enable the charging of the wearable ring device. Further, the charging controller receives input voltage from the at least one power management controller or battery to perform charging of the wearable ring device. The charging controller is connected to the battery through seventh connection and to the power management controller to the eighth connection. Further, the charging controller performs charging of the wearable ring device using the antenna through the matching circuit. The charging controller is connected to the matching circuit using ninth connection.

In an embodiment, the cover assembly and the base assembly is made of at least one of a metallic material, non-metallic material and semi-metallic material.

Accordingly, the embodiment herein is to provide a method for charging a wearable ring device using a wireless charging apparatus. The method includes receiving, by a wireless charging apparatus, a signal from a proximity sensor. Further, the method includes determining, by the wireless charging apparatus, whether the signal indicates the wearable ring device is present within a charging area of the wireless charging apparatus. Further, the method includes performing a NFC-based charging operation of the wearable ring device, when the signal indicates that the wearable ring device is present within the charging area. Further, the method includes displaying a first unique pattern of a plurality of unique patterns on an external surface of a cover assembly of the wireless charging apparatus using a first set of visual indicators and playing first a custom sound corresponding to a first set of unique patterns. The first unique pattern indicates variations in charging status of the wearable ring device. Further, the method includes displaying a second unique pattern from the plurality of unique using the first set of visual indicators, when the signal indicates that the wearable ring device is not present within the charging area. Further, the method includes playing a second custom sound corresponding to a second unique pattern. The second unique pattern indicates variations in the charging status of the wireless charging apparatus.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

### DESCRIPTION OF THE DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 is a block diagram that illustrates a wireless charging apparatus connected to wearable ring device to wirelessly charge the wearable ring device, according to the embodiments disclosed herein;

FIG. 2A is a schematic figure that illustrates an isometric view of the wireless charging apparatus, according to the embodiments disclosed herein;

FIG. 2B is a schematic figure that illustrates a front view of the wireless charging apparatus, according to the embodiments disclosed herein;

FIG. 2C is a schematic figure that illustrates a back view of the wireless charging apparatus, according to the embodiments disclosed herein;

FIG. 2D is a schematic figure that illustrates a top view of the wireless charging apparatus, according to the embodiments disclosed herein;

FIG. 2E is a schematic figure that illustrates a bottom view of the wireless charging apparatus, according to the embodiments disclosed herein;

FIG. 2F is a schematic figure that illustrates a left view of the wireless charging apparatus, according to the embodiments disclosed herein;

FIG. 2G is a schematic figure that illustrates a right view of the wireless charging apparatus, according to the embodiments disclosed herein;

FIG. 3A is a schematic figure that illustrates a wireless charging apparatus comprising circular visual indicator strips, according to the embodiments disclosed herein;

FIG. 3B-FIG. 3D is a schematic figure that illustrates a placement of antenna in the wireless charging case, according to the embodiments disclosed herein;

FIG. 3E is a schematic figure that illustrates battery on the wireless charging apparatus, according to the embodiments disclosed herein;

FIG. 4A-FIG. 4D is a schematic figure that illustrates a first unique pattern for indicating charging levels of the wearable ring device, according to the embodiments disclosed herein;

FIG. 5A-FIG. 5B is a schematic figure that illustrates second unique pattern for indicating the charging levels of the wireless charging apparatus, according to the embodiments disclosed herein;

FIG. 6A-FIG. 6B is a schematic figure that illustrates fifth unique pattern for indicating the placement status of the wearable ring device on the wireless charging apparatus, according to the embodiments disclosed herein;

FIG. 7A-FIG. 7C is a schematic figure that illustrates unique patterns for indicating wakeup alarm of the wireless charging apparatus, according to the embodiments disclosed herein;

FIG. 8A-FIG. 8C is a schematic figure that illustrates unique patterns for indicating wind down alert of the wireless charging apparatus, according to the embodiments disclosed herein;

FIG. 9A-FIG. 9C is a schematic figure that illustrates a sixth unique pattern for indicating breathing sessions for the user using the wireless charging apparatus, according to the embodiments disclosed herein;

FIG. 10A-FIG. 10C is a schematic figure that illustrates seventh unique patterns for indicating Bluetooth pairing status between the wireless charging apparatus and the wearable ring device, according to the embodiments disclosed herein;

FIG. 11 is a circuit diagram that illustrates a microcontroller for controlling the functions of wireless charging apparatus to charge the wearable ring device, according to the embodiments disclosed herein;

FIG. 12 is a circuit diagram that illustrates a charging controller to charge the wireless charging apparatus and the wearable ring device, according to the embodiments disclosed herein;

FIG. 13 is a circuit diagram that illustrates a power input port for charging the wireless charging apparatus through the external power supply, according to the embodiments disclosed herein;

FIG. 14 is a circuit diagram that illustrates a power management controller that controls the power supply to the wireless charging apparatus and the wearable ring device from the external charging port, according to the embodiments disclosed herein;

FIG. 15 is a circuit diagram that illustrates a audio output device that provides the custom sounds based on the input signal, according to the embodiments disclosed herein;

FIG. 16 is a circuit diagram that illustrates a user interface element that can be used by the user to provide the input for performing operations by the wireless charging apparatus, according to the embodiments disclosed herein;

FIG. 17 is a circuit diagram that illustrates a proximity sensor to detect whether the wearable ring device is placed within the wireless charging apparatus, according to the embodiments disclosed herein;

FIG. 18 is a circuit diagram that illustrates a hall effect sensor to detect the opening or closing of the wireless charging apparatus, according to the embodiments disclosed herein;

FIG. 19 is a circuit diagram that illustrates a visual indicator providing unique patterns to indicate the charging levels of the wireless charging apparatus and the wearable ring device, according to the embodiments disclosed herein;

FIG. 20 is a flow diagram that illustrates a method for charging a wearable ring device using a wireless charging apparatus, according to the embodiments disclosed herein.

It may be noted that, to the extent possible, like reference numerals have been used to represent like elements in the drawing. Furthermore, those of ordinary skill in the art will appreciate that elements in the drawing are illustrated for simplicity and may not necessarily have been drawn to scale. For example, the dimensions of some of the elements in the drawing may be exaggerated relative to other elements to improve the understanding of aspects of the invention. Further, the elements may have been represented in the drawing by conventional symbols, and the drawings may show only those specific details that are pertinent to understanding the embodiments of the invention so as not to obscure the drawing with details that will be readily apparent to those of ordinary skill in the art having the benefit of the description herein.

### DETAILED DESCRIPTION OF INVENTION

It may be noted that, to the extent possible, like reference numerals have been used to represent like elements in the drawing. Furthermore, those of ordinary skill in the art will appreciate that elements in the drawing are illustrated for simplicity and may not necessarily have been drawn to scale. For example, the dimensions of some of the elements in the drawing may be exaggerated relative to other elements to improve the understanding of aspects of the invention. Further, the elements may have been represented in the drawing by conventional symbols, and the drawings may show only those specific details that are pertinent to understanding the embodiments of the invention so as not to obscure the drawing with details that will be readily apparent to those of ordinary skill in the art having the benefit of the description herein.

As is traditional in the field, embodiments are described and illustrated in terms of blocks that carry out a described function or functions. These blocks, which are referred to herein as managers, units, modules, hardware components, or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by firmware and software. The circuits, for example, may be embodied in one or more semiconductor chips or on substrate supports such as printed circuit boards and the like. The circuits constituting a block may be implemented by dedicated hardware or by a processor (e.g., one or more programmed microprocessors and associated circuitry) or by a combination of dedicated hardware to perform some functions of the block and a processor to perform other functions of the block. Each block of the embodiments may be physically separated into two or more interacting and discrete blocks without departing from the scope of the proposed method. Likewise, the blocks of the embodiments may be physically combined into more complex blocks without departing from the scope of the proposed method.

The accompanying drawings are used to help easily understand various technical features, and it is understood that the embodiments presented herein are not limited by the accompanying drawings. As such, the proposed method is construed to extend to any alterations, equivalents, and substitutes in addition to those which are particularly set out in the accompanying drawings. Although the terms “first,” “second,” etc. are used herein to describe various elements, these elements are not limited by these terms. These terms are generally used to distinguish one element from another.

Accordingly, the embodiments discloses a wireless charging apparatus for charging a wearable ring device. The wireless charging apparatus comprises a cover assembly and a base assembly. Further, the cover assembly comprises a first set of visual indicators embedded in an external surface of the cover assembly. The base assembly is connected to the cover assembly. The base assembly comprises a charging area, a proximity sensor, and a microcontroller. The charging area is provided in an internal region of the base assembly in which the wearable ring device is placed for charging. The proximity sensor is configured to detect a presence of the wearable ring device within the charging area. The microcontroller is connected to the first set of visual indicators. Also, the microcontroller receives a signal indicating whether the wearable ring device is present within the charging area from the proximity sensor. Further, when the signal indicates that the wearable ring device is present within the charging area, the microcontroller performs a NFC-based charging operation of the wearable ring device. Further, displays a first unique pattern of a plurality of unique patterns using the first set of visual indicators and plays a first custom sound corresponding to the first unique pattern. The first unique pattern indicates variations in a charging status of the wearable ring device. Further, when the signal indicates that the wearable ring device is not present within the charging area, the microcontroller displays a second unique pattern from the plurality of unique patterns using the first set of visual indicators and plays a second custom sound corresponding to the second unique pattern. The second unique pattern indicates variations in a charging status of the wireless charging apparatus.

Accordingly, the embodiment herein is to provide a method for charging a wearable ring device using a wireless charging apparatus. The method includes receiving, by a wireless charging apparatus, a signal from a proximity sensor. Further, the method includes determining, by the wireless charging apparatus, whether the signal indicates the wearable ring device is present within a charging area of the wireless charging apparatus. Further, the method includes performing a NFC-based charging operation of the wearable ring device, when the signal indicates that the wearable ring device is present within the charging area. Further, the method includes displaying a first unique pattern of a plurality of unique patterns on an external surface of a cover assembly of the wireless charging apparatus using a first set of visual indicators and playing first a custom sound corresponding to a first set of unique patterns. The first unique pattern indicates variations in charging status of the wearable ring device. Further, the method includes displaying a second unique pattern from the plurality of unique patterns using the first set of visual indicators, when the signal indicates that the wearable ring device is not present within the charging area. Further, the method includes playing a second custom sound corresponding to a second unique pattern. The second unique pattern indicates variations in the charging status of the wireless charging apparatus.

The proposed invention provides a portable wireless charging apparatus for a wearable ring device with an enhanced interactive user interface. The portable wireless charging apparatus is designed to be compact and lightweight, making it easy to carry around. This makes it ideal for people who are always on the move and need to charge their wearable ring device frequently. Also, the wireless charging apparatus of the proposed invention is provided with the wireless charging capability to charge the wearable ring device, when the wearable ring device is placed inside the portable wireless charging apparatus. The charging case is also designed to be durable and long-lasting, ensuring that it provides reliable charging for an extended period. With the portable wireless charging apparatus with wireless charging capability, users can enjoy the benefits of their wearable ring device without worrying about battery life.

Also, the wireless charging apparatus provides a magic glyph interface on the wireless charging apparatus to indicate the various charging levels of both the wireless charging apparatus and the wearable ring device. The magic glyph interface includes a series of symbols that light up to indicate the charging level of the devices which makes it easy to use and understand. Further, the wireless charging apparatus comprises a multi-functionality user interface element that provides a multi functionality interaction mode to perform various operations using the wireless charging apparatus.

Further, the wireless charging apparatus comprises a audio output device that can play different custom sound to indicate various operations of the wireless charging apparatus.

Further, the wireless charging apparatus provides a power input port on the portable wireless charging apparatus that can be used to power the wireless charging apparatus through an external power supply.

Further, the wireless charging apparatus can be used to share the activity data between the mobile device and the wearable ring device.

Further, the wireless charging apparatus is capable of determining a feasible wake-up time based on sleep stage data of the user. The sleep stage data is the duration data of different modes of sleep. For example, different sleep stages can include, but are not limited to Sleep Onset Time, REM stage, Non REM stage.

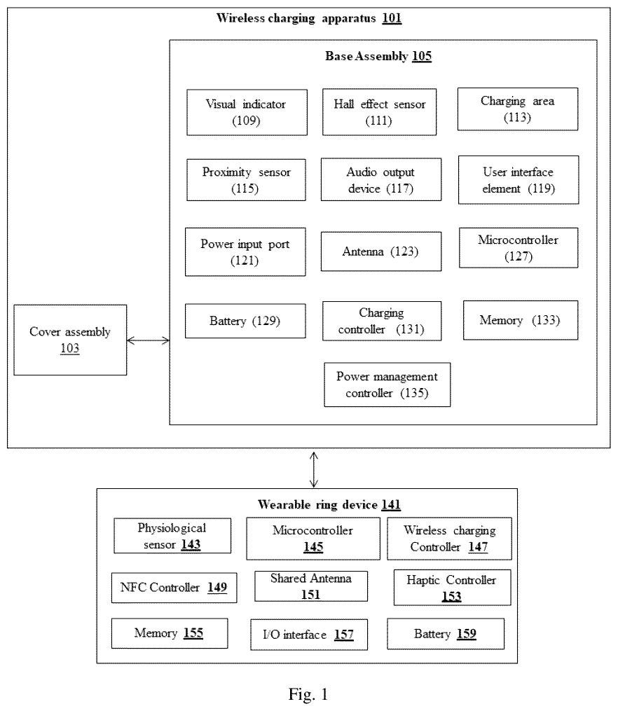

FIG. 1 is a block diagram that illustrates a wireless charging apparatus connected to wearable ring device to wirelessly charge the wearable ring device, according to the embodiments disclosed herein.

The wireless charging apparatus (101) comprises a cover assembly (103) and a base assembly (105) that are connected to each other. The cover assembly (103) is placed over the base assembly (105) to form an enclosure within which wireless charging of the wearable ring device can be performed. The cover assembly and base assembly of the wireless charging apparatus are designed to fit together seamlessly, creating an enclosure that protects the wearable ring device during the charging process. This enclosure also ensures that the charging process is efficient and effective, as the wireless charging technology is optimized to work within the confines of the enclosure. The cover assembly and base assembly are also designed to be durable and long-lasting, ensuring that the wireless charging apparatus can withstand regular use and remain functional for an extended period.

The cover assembly (103) is made of a durable and lightweight material that can withstand wear and tear. The outer surface of the cover assembly (103) is coated with a scratch-resistant material that prevents scratches and scuffs from appearing on the surface. The inner surface of the cover assembly (103) is lined with a soft and cushioned material that protects the wearable ring device and wireless charging case from impact and shock. This design ensures that the wearable ring device and wireless charging case remain safe and secure at all times.

The base assembly (105) comprises a charging area (113), a visual indicator (109), a hall effect sensor (111), a proximity sensor (115), a audio output device (117), a user interface element (119), a power input port (121), an antenna (123), a microcontroller (127), a battery (129), a charging controller (131), a power management controller (135), and a memory (133).

The visual indicators (109) are designed to emit light in different unique patterns, which are controlled by the microcontroller (127) of the wireless charging apparatus (101). The microcontroller (127) is programmed to deliver plurality unique predefined patterns to indicate various operations associated with the wearable ring device (141) and the wireless charging apparatus (101). The microcontroller (127) is connected to the power management controller (135) that provides the necessary voltage and current to operate the visual indicators (109). Each unique pattern of the plurality of unique patterns are programmed to change at least one of colour, blink, and animate in various sequences to convey the variations in the charging status of at least one of the wearable ring device and the wireless charging apparatus.

The visual indicators (109) are arranged in a specific pattern to create a visually appealing effect that can be easily recognized by the user. For example, the visual indicators can be Light Emitting diodes (LEDs) and the like. The unique patterns displayed by the visual indicators (109) are designed to be aesthetically pleasing and to enhance the user experience. For example, the LEDs (109) may be arranged in a circular pattern to mimic the shape of the wearable ring device (141) or in a linear pattern to indicate the charging status of the wireless charging apparatus (101). The visual indicators (109) can be placed at first visual area that displays the first unique pattern indicating the variations in charging status of the wearable ring device. Also, the visual indicators (109) can be placed at second visual area displaying the second unique pattern indicating the variations in charging status of the wireless charging apparatus.

The microcontroller (127) is programmed to deliver different unique patterns of light to indicate the status of the wearable ring device (141) and the wireless charging apparatus (101). For example, the visual indicators (109) may flash a certain colour when the wearable ring device (141) is fully charged or display a different pattern when the wearable ring device (141) is in use. The microcontroller (127) is also designed to detect any errors or malfunctions in the system and to display an appropriate pattern of light to alert the user.

The power management controller (135) supplies power to the battery (129), the charging controller (131), visual indicators (109), proximity sensor (115) and the hall effect sensor (111). The power management controller (135) provides the necessary voltage and current to operate the visual indicators (109) which is designed to be efficient and reliable. The power management controller (135) is designed to provide a stable voltage and current to the microcontroller (127) and the visual indicator (109) to ensure that they operate correctly and efficiently.

Furthermore, an LED guideway is placed above the array of visual indicators (109). This guideway is designed to diffuse the light emitted by the visual indicators (109), creating a softer, more even glow. This not only looks better but also reduces eye strain and makes it easier to see the visual indicators (109) in bright sunlight. The LED guideway is made of a transparent material that allows light to pass through it. The guideway is designed to diffuse the light emitted by the array of visual indicators (109) to create a uniform and consistent illumination. The guideway is placed above the array of visual indicators (109) to ensure that the light is evenly distributed across the cover assembly.

For example, the transparent material used for the cover assembly (103) is a polycarbonate material that is durable and resistant to scratches and impacts. This material also has a high degree of transparency, allowing for clear and unobstructed viewing of the visual indicators (109) and user interface. Additionally, the cover assembly (103) may be coated with an anti-glare or anti-reflective coating to reduce glare and improve visibility in bright lighting conditions.

In an embodiment, the cover assembly (103) may be designed with a specific shape or curvature to optimize the viewing angle of the visual indicators (109) and user interface. This may involve using advanced computer-aided design (CAD) software to model the cover assembly and simulate different viewing scenarios. The resulting design may be optimized for maximum visibility and clarity, taking into account factors such as the distance between the user and the device, the angle of the device, and the lighting conditions in the surrounding environment.

In an embodiment, the cover assembly (103) may be designed to provide additional functionality beyond simply protecting the visual indicators (109) and user interface. For instance, the cover assembly (103) may include touch sensitive areas that allow the user to interact with the device without having to physically touch the screen or buttons.

In an embodiment, the cover assembly (103) may be designed to be easily removable and replaceable, allowing for easy maintenance and repair of the device. This may involve using a snap-on or clip-on mechanism to attach the cover assembly to the device, or using a simple screw or bolt system to secure the cover assembly (103) in place. Additionally, the cover assembly (103) may be designed to be easily cleaned and disinfected, using materials that are resistant to bacteria and other pathogens.

The hall effect sensor (111) is placed at the outer surface of the base assembly (105) to detect opening and closing of the cover assembly (103). The hall effect sensor (111) detects whether the cover of the wireless charging apparatus (101) is opened or closed. The hall effect sensor (111) sends signals to the microcontroller (127), when the cover of the wireless charging apparatus (101) is opened or closed. Irrespective of the cover being opened or closed, the wireless charging apparatus (101) will charge the wearable ring device (141), when the wearable ring device is placed within the core region (113) of the base assembly (105).

The hall effect sensor (111) is a type of magnetic sensor that is used to detect the opening and closing of the cover assembly (103). The hall effect sensor (111) is placed at the outer surface of the base assembly (105) and is connected to the microcontroller (127). When the cover assembly (103) is opened, the hall effect sensor (111) detects the change in magnetic field and sends a signal to the microcontroller (127) indicating the cover being opened. Similarly, when the cover assembly (103) is closed, the hall effect sensor (111) detects the change in magnetic field again and sends a signal to the microcontroller (127) indicating the cover is closed.

Further, the charging area (113) in the base assembly (105) is an internal region in which the wearable ring device (141) is placed for charging. In an embodiment, the charging area (113) is a region that can be used to place wearable devices such as smart chain, smart bangle and the like for charging.

The proximity sensor (115) is a type of sensor that detects the presence of an object without physical contact. In this case, the proximity sensor (115) is used to detect the presence of the wearable ring device (141) within the charging area (113). The proximity sensor (115) detects the presence of the wearable ring device (141) within the charging area. The proximity sensor (115) works by emitting an electromagnetic field and then measuring the changes in the field caused by the presence of the ring. This information is then sent to the microcontroller (127) for processing.

The user interface element (119) receives input from the user to perform one or more operations when an input is received from the user for a defined period of time. The user interface element (119) is a mechanical component that receives input from the user to perform various operations. The user interface element (119) sends signals to the microcontroller (127) to initiate the desired operation. The user interface element (119) is designed to be durable and responsive to ensure that the user can easily interact with the device. The one or more operation is performed by the wireless charging apparatus (101), when the user interface element (119) is pressed for a corresponding predefined period. For example, the user interface element can be a button, touch pad and the like. For example, when the user interface element (119) is pressed continuously for 15 seconds, then the wireless charging apparatus (101) is reset. In another embodiment, when the user interface element (119) is pressed or held for 3 seconds then at least one of a 20 default operation set by the user is performed, or stops the timer operation or guided operation if it is running or does not perform any operation. Similarly, when multiple pushes of the user interface element (119) are made by the user, then only the latest button press is considered. In another embodiment, when the user interface element (119) is pressed for less than 0.5 seconds then the charging levels of the wearable ring device (141) or the wireless charging apparatus (101) can be displayed over the visual indicators (109).

The one or more operations can include, but not limited to determining and displaying various charging levels of the wearable ring device (141), determining and displaying various charging levels of the wireless charging case, determining and indicating whether the cover assembly being opened, determining and displaying a progress and completion of a firmware update, determining and indicating when wireless charging apparatus is misplaced, displaying a wind down alert, determining and displaying wake-up alarm, determining and displaying breathing states of a user wearing the wearable ring device, determining and displaying a Bluetooth connectivity between the wearable ring device and the wireless charging apparatus, or determining and displaying incorrect placement of wearable ring device in the wireless charging case.

The audio output device (117) plays custom sound based on the one or more operations performed by the wireless charging apparatus (101). The audio output device (117) is an electroacoustic transducer that converts electrical signals into sound waves. For example, the audio output device (117) can be a speaker, buzzer and the like. In this case, the audio output device (117) is used to play a custom sound based on the various operations performed or the input signals received from the microcontroller (127). The audio output device (117) (hereinafter) is connected to the electronic assembly (107) and receives signals from the microcontroller (127) to play the custom sound. The audio output device (117) is designed to be compact and efficient to ensure that it does not consume too much power. For example, the audio output device (117) can play a custom sound for 0.5 seconds when the battery of the wireless charging case is low. Similarly, the audio output device (117) plays a custom sound for about 0.25 seconds to indicate the wake-up alarm for the users. Also, the wake-up alarm can be played having a gap of 0.5 seconds to wake-up the user. Also, the audio output device (117) plays a custom sound for about 0.25 seconds to provide a notification about the start/end of wind down time, start/end of timer, start/end of the guided breathing sessions. Also, the audio output device (117) plays a sound for about 0.5 seconds to provide a wrong ring positioning alert.

The power input port (121) is a connector that allows the wireless charging apparatus (101) to be charged using an external power supply. The power input port (121) receives voltage signals from external power supply to charge the wireless charging apparatus (101). In this case, the power input port (121) is used to connect the wireless charging apparatus (101) to an external power supply for charging. The power input port (121) is designed to be durable and reliable to ensure that the device can be charged quickly and safely. The power input port (121) is also designed to be compatible with a wide range of power supplies to ensure that the device can be charged in different locations. For example, the power input port (121) can be a USB-C port and the like.

The microcontroller (127) receives input signals from a proximity sensor (115) and a hall effect sensor (111). The proximity sensor (115) indicates when the wearable ring device (141) is placed within the charging area (113) of the base assembly (105), while the hall effect sensor (111) indicates when the wireless charging apparatus (101) is opened or closed. Once the microcontroller (127) receives these input signals, it sends a control signal to the charging controller (131) to enable wireless charging of the wearable ring device (141). The charging controller (131) then begins to charge the ring wirelessly. Once the indication of the wireless charging apparatus (101) being closed is received from the hall effect sensor (111), the microcontroller (127) enables the wireless charging. During the wireless charging process, the microcontroller (127) monitors the level of charge of the wearable ring device (141). The array of visual indicators (109) is used to display a unique pattern based on the level of charge of the wearable ring device (141), when the user presses the button (119) for about 0.5 seconds to view the battery levels of the wearable ring device (141) or wireless charging case (101). The pattern changes as the level of charge increases or decreases. This provides the user with a visual indication of the charging status of the wearable ring device (141). The visual indicators (109) are controlled by the microcontroller (127) and can display a wide range of colours and patterns.

The charging controller (131) performs the charging of the wearable ring device (141) when the wearable ring device (141) is placed within the charging area (113). The charging controller (113) receives the voltage supply from the power management controller (135) for charging the wearable ring device (141), when the wireless charging case (101) is powered from external power supply through the power input port (121). Also, the charging controller (131) receives the voltage supply from the battery (129) of the wireless charging case (101) to charge the wearable ring device (141), when the wireless charging apparatus (101) is not powered from external power supply through the power input port (121). The charging controller (131) performs the charging of the wearable ring device (141), when the control signal is received from the microcontroller (127). The charging controller (131) performs the charging of the wearable ring device (141) through the antenna (123). The charging controller (131) sends the signals to the antenna (123) of the wireless charging apparatus (101). The antenna (123) generates the electromagnetic fields that are received or detected by the antenna (151) of the wearable ring device placed within the core region (113) of the wireless charging case (101). The electromagnetic field generated by the wireless charging case (101) induces the current in the antenna (151) of the wearable ring device (141) that results in charging of the wearable ring device (141).

The battery (129) of the wireless charging case (101) receives the voltage supply from the power management controller (135). Further, the battery (129) supplies the power supply to the charging controller (131) to charge the wearable ring device (141) placed within the wireless charging case (101).

The memory (133) can store or log the information regarding whether the case is opened or closed. Also, the memory (133) stores the information regarding the wearable ring device (141) being placed within the wireless charging case or not. Also, the memory (133) can store other information received from the microcontroller (127) that may be required for charging the wearable ring device (141).

The wearable ring device (141) receives the electromagnetic field generated by the wireless charging apparatus (101) using the shared antenna (151) that induces the current in the wearable ring device (141) which further results in charging of the wearable ring device (141).

In an embodiment, the wearable ring device (141) is connected to the wireless charging apparatus (101). The wireless charging apparatus (101) is used to charge the wearable ring device (141) when it is placed within the case. The wearable ring device (141) includes a physiological sensor (143), a battery (159), a microcontroller (145), an NFC controller (149), a shared antenna (151), a haptic controller (153), and a wireless charging controller (147). Also, a wireless charging mode is activated in the wearable ring device (141) when the microcontroller (145) does not receive any signals from the skin proximity sensor. Additionally, the wearable ring device (141) performs NFC communication when the microcontroller (145) receives signals from the skin proximity sensor. The NFC communication and wireless charging of the wearable ring device (141) occurs using the shared antenna (151). The haptic controller (153) provides haptic feedback to indicate the NFC communication or wireless charging performed by the wearable ring device (141).

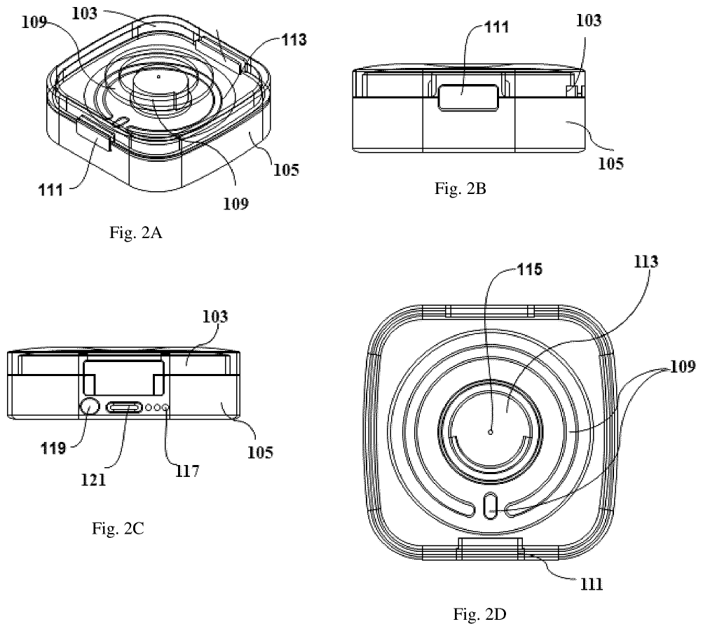

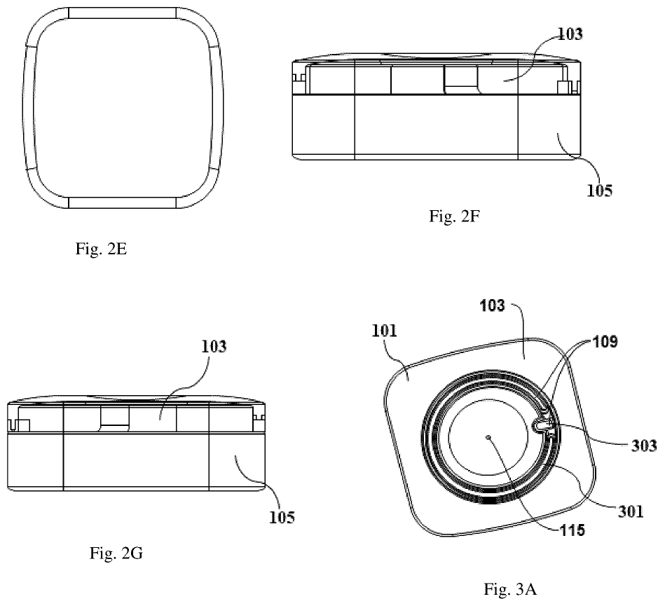

FIG. 2A is a schematic figure that illustrates an isometric view of the wireless charging apparatus, according to the embodiments disclosed herein.

The wireless charging apparatus (101) is designed to charge a wearable ring device (141) and comprises a cover assembly (103) and a base assembly (105). The base assembly (105) includes a hall effect sensor (111) that detects the opening and closing of the wireless charging apparatus (101). Additionally, an array of visual indicators (109) is present on the top surface of the wireless charging apparatus (101) to indicate the operations performed by the case.

The cover assembly (103) is connected to the base assembly (105) to form the wireless charging apparatus (101). The base assembly (105) comprises a charging area (113). The charging area (113) is the area where the wearable ring device (141) is placed for charging. The visual indicators (109) deliver a plurality of unique pattern that indicates the operations performed by the wireless charging apparatus (101).

The wireless charging apparatus (101) is designed to be compact and portable, making it easy to carry around. The cover assembly (103) is made of a durable material that can withstand wear and tear. The wireless charging apparatus (101) is also designed to be energy-efficient, and consuming minimal power. The array of visual indicators (109) on the top surface of the wireless charging apparatus (101) is designed to be bright and visible, even in low-light conditions.

The wireless charging apparatus (101) is compatible with a wide range of wearable ring devices (141) and can charge them quickly and efficiently. The hall effect sensor (111) is designed to be highly sensitive, ensuring that the opening and closing of the case is determined accurately. Additionally, the wireless charging apparatus (101) is designed to be user-friendly, with a simple and intuitive interface that makes it easy to use.

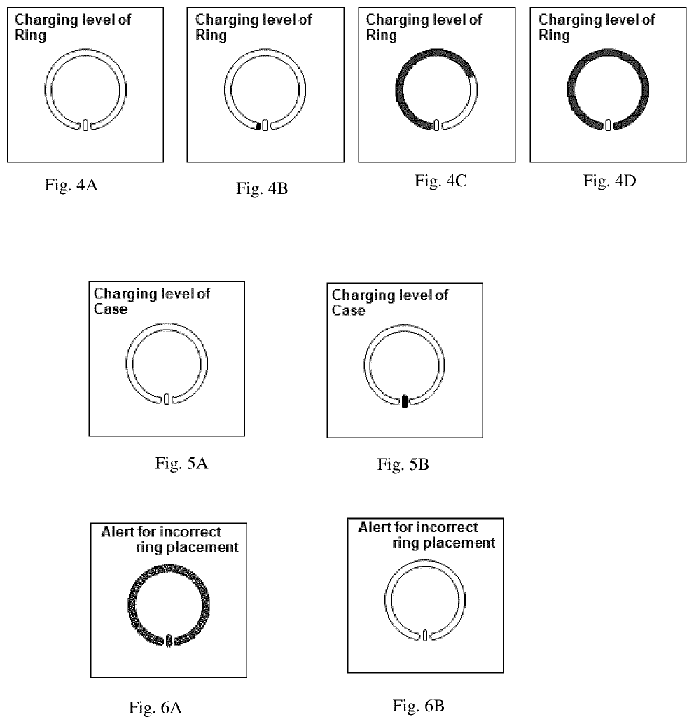

The wireless charging apparatus (101) includes an array of visual indicators (109) that delivers plurality of unique patterns to indicate various operations. The visual indicators (109) provide a first unique pattern to indicate the charging levels of the wearable ring device (141), as shown in FIG. 4A-FIG. 4D. Additionally, the visual indicators (109) provide a second unique pattern to indicate the charging levels of the wireless charging case, as shown in FIG. 5A-FIG. 5B. The visual indicators (109) also provide a fifth unique pattern for indicating placement status of the wearable ring device (141) within the wireless charging status (101), as shown in FIG. 6A-FIG. 6B.

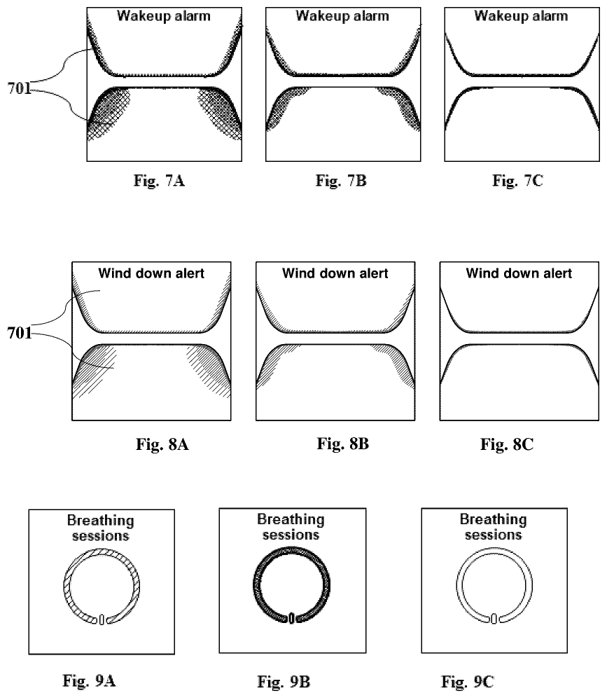

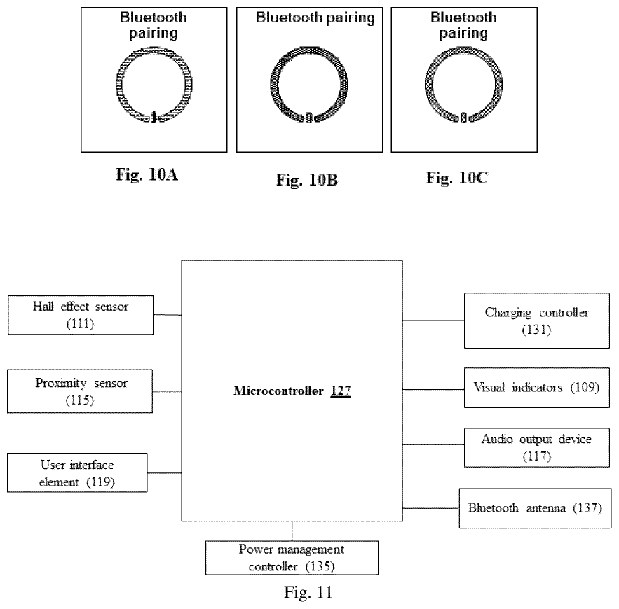

The wireless charging apparatus (101) further includes unique patterns for indicating the wake-up alarm, as shown in FIG. 7A-FIG. 7B. The visual indicators (109) also provides unique patterns for indicating the wind-down alert, as shown in FIG. 8A-FIG. 8C. Additionally, the visual indicators (109) provides a sixth unique pattern for indicating breathing sessions, as shown in FIG. 9A-FIG. 9C. The status of the Bluetooth pairing between the wireless charging case (101) and the mobile device is indicated by a seventh unique pattern, as shown in FIG. 10A-FIG. 10C.

The visual indicators (109) deliver the unique patterns based on the operations performed by the wireless charging apparatus (101). The wireless charging apparatus (101) performs the operations using power and voltage received from the power management controller (135). The various operations performed by the wireless charging apparatus (101) are based on the desired input provided by the user for performing a particular operation. The visual indicators provides a visual indication of the status of the wireless charging case (101) and the wearable ring device (141) to the user.

FIG. 2B is a schematic figure that illustrates a front view of the wireless charging apparatus, according to the embodiments disclosed herein.

The wireless charging apparatus (101) is designed to charge wearable ring devices (141) wirelessly. The cover assembly (103) and the base assembly (105) are connected to each other to form a protective case for the wearable ring device (141). The cover assembly (103) is designed to open and close to allow the wearable ring device to be inserted and removed from the case.

In addition to the cover assembly (103) and the base assembly (105), the wireless charging apparatus (101) includes a number of other components. One of these components is the hall effect sensor (111), which is used to detect the opening and closing of the wireless charging case (101). The hall effect sensor (111) is a type of magnetic sensor that detects changes in magnetic fields. When the cover assembly (103) is opened or closed, the magnetic field around the hall effect sensor (111) changes, which triggers the sensor to send a signal to the wearable ring device (141).

The wireless charging apparatus (101) also includes a wireless charging controller (131), which is used to charge the wearable ring device (141) wirelessly. The wireless charging controller (131) is located inside the base assembly (105) and is connected to a power source. When the wearable ring device is placed inside the wireless charging apparatus (101), the wireless charging controller (131) generates an electromagnetic field, which induces a current in the wearable ring device's battery, thereby charging it wirelessly.

To ensure that the wearable ring device (141) is properly aligned with the wireless charging controller (131), the wireless charging apparatus (101) includes a positioning mechanism. The positioning mechanism is designed to guide the wearable ring device (141) into the correct position inside the case, so that the wireless charging controller (131) can charge the battery efficiently. The core region of the wireless charging apparatus (101) has positioners and the wearable ring device (141) has lenses which are stopped by the positioners. Thus, the lenses on the wearable ring device (141) and the positioners on the wireless charging case ensure the correct placement of the wearable ring device (141) within the wireless charging apparatus (101). Further, the rotational allowance of the core region will be less than degrees and hence does not impact the wireless charging.

FIG. 2C is a schematic figure that illustrates a back view of the wireless charging apparatus, according to the embodiments disclosed herein.

The wireless charging apparatus (101) includes a user interface element (119), a power input port (121), and the audio output device (117). The user interface element (119) is a mechanical component that receives input from the user to perform various operations. In an embodiment, the user interface element (119) sends signals to the microcontroller (127) to initiate the desired operation, when it receives the input from the user.

The wireless charging apparatus (101) performs the desired operation when the user interface element (119) is pressed for a defined period of time. For example, when the user interface element (119) is pressed continuously for 15 seconds, the wireless charging apparatus (101) is reset. In another embodiment, when the user interface element (119) is pressed or held for 3 seconds, at least one of a default operation set by the user is performed or stops the timer operation or guided operation if it is running or does not perform any operation. Similarly, when multiple pushes of the user interface element (119) are made by the user, then only the latest press is considered.

In another embodiment, when the user interface element (119) is pressed for less than 0.5 seconds, then the charging levels of the wearable ring device (141) or the wireless charging case (101) can be displayed over the visual indicators (109). The power input port (121) is a connector that allows the wireless charging apparatus (101) to be charged using an external power supply. In this case, the power input port (121) is used to connect the wireless charging apparatus (101) to an external power supply for charging.

For example, the power input port (121) can include, but is not limited to, a USB-C type port. The audio output device (117) is used to play a custom sound based on the various operations performed or the input signals received from the microcontroller (127). For example, the audio output device (117) can play a custom sound for 0.5 seconds when the battery of the wireless charging case is low. Similarly, the audio output device (117) plays a custom sound for about 0.25 seconds at a frequency of 0.5 seconds to indicate the wake-up alarm for the users.

Also, the audio output device (117) plays a sound for about 0.25 seconds to provide a notification about the start/end of wind down time, start/end of timer, start/end of the guided breathing sessions. Additionally, the audio output device (117) plays a sound for about 0.5 seconds to provide a wrong ring positioning alert. The custom sound provided by the audio output device (117) can be customized by the user by using the user voice.

FIG. 2D is a schematic figure that illustrates a top view of the wireless charging apparatus, according to the embodiments disclosed herein.

The wireless charging apparatus (101) is designed to wirelessly charge a wearable ring device (141). The inner side of the wireless charging apparatus (101) comprises a proximity sensor (115) that detects the presence and placement of the wearable ring device (141) within the charging area (113).

The wireless charging apparatus (101) comprises an array of visual indicators (109) placed on the outer surface. The array of visual indicators (109) is designed to deliver light when the presence of the wearable ring device (141) is detected by the proximity sensor (115) and when the closed position of the cover of the wireless charging apparatus (101) is detected by the hall effect sensor (111). The hall effect sensor (111) is a type of sensor that detects the presence of a magnetic field. In this case, the hall effect sensor (111) is used to detect the closed position of the cover of the wireless charging apparatus (101).

The proximity sensor (115) is a type of sensor that uses an electromagnetic field or radiation to detect the presence of an object without physical contact. The proximity sensor (115) is designed to detect the presence and placement of the wearable ring device (141) within the charging area (113) of the wireless charging apparatus (101). The charging area (113) is the area of the wireless charging apparatus (101) where the wearable ring device (141) is placed for charging.

The array of visual indicators (109) is designed to deliver light to indicate the one or more operations performed by the wireless charging apparatus (101) based on the user providing the input through the user interface element (119). For example, when a user presses the user interface element (119) for about 5 seconds, the visual indicators (109) will display the charging levels of the wearable ring device (141) or the wireless charging apparatus (101). Similarly, the visual indicators will glow in a predefined pattern when there is no charge or when the charge in the battery is less than predefined threshold value to indicate that the wireless charging apparatus needs to be charged due to the low charging levels. The presence of the wearable ring device (141) is detected by the proximity sensor (115) and when the closed position of the cover of the wireless charging apparatus (101) is detected by the hall effect sensor (111). The visual indicators (109) are placed on the outer surface of the wireless charging case (101) and is used to indicate the charging status of the wearable ring device (141). The visual indicators (109) can be programmed to display different colors or patterns to indicate different charging levels or modes.

FIG. 2E is a schematic figure that illustrates a bottom view of the wireless charging apparatus, according to the embodiments disclosed herein.

FIG. 2F is a schematic figure that illustrates a left view of the wireless charging apparatus, according to the embodiments disclosed herein.

FIG. 2G is a schematic figure that illustrates a right view of the wireless charging apparatus, according to the embodiments disclosed herein.

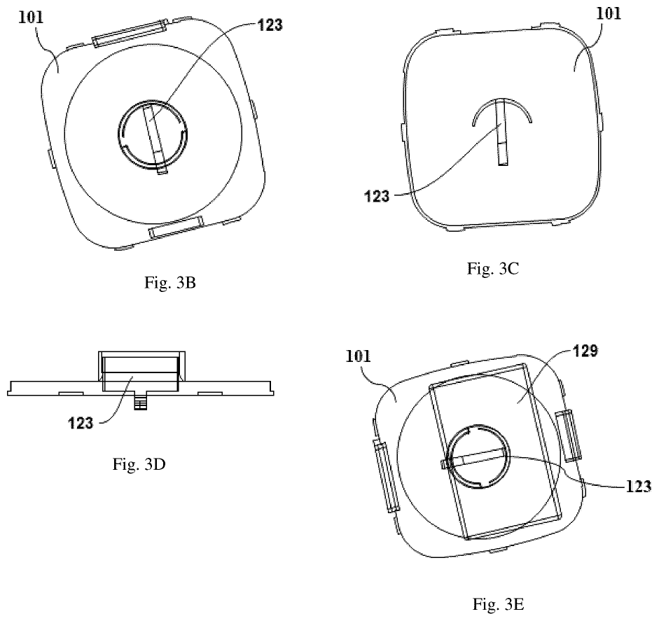

FIG. 3A is a schematic figure that illustrates a wireless charging apparatus comprising circular visual indicator strips, according to the embodiments disclosed herein. The wireless charging apparatus (101) includes a power source (not shown) that provides power to the charging circuitry (not shown) to charge the battery of the wearable ring device (141). The array of visual indicators (109) strips on the outer surface of the wireless charging apparatus (101) can be used to indicate the charging levels of the wireless charging apparatus (101) or the wearable ring device (141). The first visual area (301) displays the first unique pattern indicating the variations in charging status of the wearable ring device (141). Similarly, the second visual area (303) displaying the second unique pattern indicating the variations in charging status of the wireless charging apparatus (101). The array of visual indicators (109) includes the light-emitting elements arranged in the first visual area in a circular or semicircular configuration to form the variations in the charging status of the wearable ring device (141), and wherein the second visual area is in proximity to the first visual area. The proximity sensor (115) on the inner surface of the wireless charging apparatus (101) detects the presence of the mobile device and activates the charging circuitry (not shown) to charge the battery of the mobile device. The visual indicators (109) glows based on the input provided by the user to perform various operations. The one or more operations requested by the user can include but not limited to indicate the charging levels of the wireless charging apparatus (101) or the wearable ring device (141), activation of the Find my function in the mobile device to find the misplaced wireless charging apparatus (101), activation of the lost mode in the mobile device to ensure that the wireless charging apparatus (101) does not connect with any other device when the wireless charging apparatus (101) is lost, and wake-up alarm indication. Additionally, the visual indicators (109) glow when the incorrect placement of the wearable ring device (141) is detected within the wireless charging apparatus (101). In an embodiment, the visual indicators (109) glow to indicate the status of the firmware update, the status of the Bluetooth pairing, breathing sessions, wind down alert, and the like.

The wireless charging apparatus (101) can be made of any suitable material, such as plastic, metal, or a combination thereof. The array of visual indicators (109) strips on the outer surface of the wireless charging apparatus (101) can be arranged in any suitable pattern, such as a circular pattern, a rectangular pattern, or a combination thereof. The proximity sensor (115) on the inner surface of the wireless charging apparatus (101) can be any suitable type of sensor, such as a capacitive sensor, an inductive sensor, or a combination thereof. The charging circuitry (not shown) can be any suitable type of circuitry, such as a resonant circuit, a non-resonant circuit, or a combination thereof. The wearable ring device (141) can be made of any suitable material, such as plastic, metal, or a combination thereof. The wearable ring device (141) can include any suitable type of sensor, such as a temperature sensor, a heart rate sensor, or a combination thereof. The wearable ring device (141) can communicate with the mobile device using any suitable type of communication protocol, such as Bluetooth, Wi-Fi, or a combination thereof. The wearable ring device (141) can be charged using the wireless charging apparatus (101) or any other suitable charging device.

FIG. 3B-FIG. 3D is a schematic figure that illustrates a placement of antenna in the wireless charging case, according to the embodiments disclosed herein. In this embodiment, the antenna (123) is placed on the top surface of the wireless charging apparatus (101) to ensure maximum coverage area for the electromagnetic field. The antenna (123) is designed to operate at a frequency range of 13.56 MHz. The antenna (123) is connected to the charging controller (131) to perform the wireless charging of the wearable ring device (141).

The antenna (123) generates the electromagnetic field that is received or detected by the antenna (151) of the wearable ring device (141) placed within the core region (113) of the wireless charging apparatus (101). The charging area (113) is designed to have a high magnetic coupling to ensure efficient wireless charging of the wearable ring device (141).

The electromagnetic field generated by the wireless charging apparatus (101) induces the current in the antenna (151) of the wearable ring device (141) that results in wireless charging of the wearable ring device (141). The wearable ring device (141) is designed to have a resonant frequency that matches the frequency of the electromagnetic field generated by the wireless charging apparatus (101). The resonant frequency of the wearable ring device (141) is achieved by matching circuits associated with the antenna (151) of the wearable ring device (141).

The antenna (123) receives the signals from the charging controller (131). The charging controller (125) is responsible for controlling the wireless charging process and ensuring the safety of the charging process. The charging controller (131) monitors the temperature and voltage of the wireless charging apparatus (101) and the wearable ring device (141) to prevent overcharging and overheating. The charging controller (131) also communicates with the wireless charging controller (147) of the wearable ring device (141) to ensure proper communication between the wearable ring device (141) and the wireless charging apparatus (101).

FIG. 3E is a schematic figure that illustrates battery on the wireless charging apparatus, according to the embodiments disclosed herein.

The battery (129) of the wireless charging apparatus (101) receives the voltage supply from the power management controller (135). Further, the battery (129) supplies the power supply to the charging controller (131) to charge the wearable ring device (141) placed within the wireless charging case (101).

FIG. 4A-FIG. 4D is a schematic figure that illustrates a first unique pattern for indicating charging levels of the wearable ring device, according to the embodiments disclosed herein. The unique patterns are designed to provide a visual indication of the charging status of the wearable ring device. The unique patterns are arranged in a specific sequence to indicate the charging level of the wearable ring device (141).

The FIG. 4A-FIG. 4B illustrates an initial state of charging of the wearable ring device (141) placed within the wireless charging apparatus (101). The wireless charging apparatus (101) is designed to charge the wearable ring device (141) wirelessly. The charging process is initiated when the wearable ring device (141) is placed within the wireless charging apparatus (101). The wireless charging apparatus (101) uses electromagnetic induction to transfer power to the wearable ring device (141).

FIG. 4C illustrates an indication of the charging percentage of the wearable ring device (141). The unique patterns on the wearable ring device (141) are designed to indicate the charging percentage of the wearable ring device (141). The unique patterns are arranged in a specific sequence to indicate the charging percentage of the wearable ring device (141). The unique patterns change as the charging percentage of the wearable ring device (141) increases.

FIG. 4D illustrates an indication of the completion of the charging of the wearable ring device (141). The unique patterns on the wearable ring device (141) are designed to indicate the completion of the charging process. The unique patterns change to a specific color to indicate that the charging process is complete. The wireless charging apparatus (101) automatically stops charging the wearable ring device (141) when the charging process is complete.

FIG. 5A-FIG. 5B is a schematic figure that illustrates second unique pattern for indicating the charging levels of the wireless charging apparatus, according to the embodiments disclosed herein. In one embodiment, the unique patterns may include the visual indicators that illuminates when the wireless charging apparatus (101) is initially connected to a power source. The visual indicator (109) may be green in color to indicate that the charging process has begun. Additionally, the visual indicators (109) may blink at a predetermined frequency to indicate that the wireless charging apparatus (101) is in the process of charging.

FIG. 5B illustrates the completion of the charging of the wireless charging apparatus (101). In one embodiment, the unique patterns may illuminate in a specific sequence to indicate the charging level of the wireless charging apparatus. For example, when the wireless charging apparatus is fully charged, all the visual indicators may illuminate in a steady state. Alternatively, when the wireless charging apparatus (101) is partially charged, only a subset of the visual indicators (109) may illuminate in a specific sequence to indicate the remaining charging level.

In another embodiment, the unique patterns may include a unique sequence of flashing patterns that indicate the level of battery charge remaining in the wireless charging apparatus (101). For example, the unique patterns may include a slow flashing sequence that indicates a low battery level, while a fast flashing sequence may indicate a critically low battery level. Additionally, the unique patterns may include a solid color sequence that indicates the charging status of the wireless charging apparatus.

In yet another embodiment, the unique patterns may include a unique sequence of colors and flashing patterns that indicate the charging status and battery level of the wireless charging case. For example, the unique patterns may include a green flashing sequence that indicates the wireless charging case is charging, while a solid green color may indicate a fully charged battery. Additionally, the unique patterns may include a red flashing sequence that indicates a low battery level, while a solid red color may indicate a critically low battery level.

The unique pattern is controlled by the microcontroller (127) that is integrated into the wireless charging apparatus (101). The microcontroller (127) may be programmed to monitor the charging level of the wireless charging apparatus and control the unique patterns accordingly. Additionally, the microcontroller (127) is configured to adjust the charging current and voltage based on the charging level of the wireless charging apparatus (101) to optimize the charging process.

In some embodiments, the wireless charging apparatus (101) may include a temperature sensor that is integrated into the microcontroller (127). The temperature sensor may be used to monitor the temperature of the wireless charging apparatus (101) during the charging process. If the temperature of the wireless charging apparatus (101) exceeds a predetermined threshold, the microcontroller (127) may adjust the charging current and voltage to prevent overheating and damage to the wireless charging case.

FIG. 6A-FIG. 6B is a schematic figure that illustrates fifth unique pattern for indicating the placement status of the wearable ring device on the wireless charging apparatus, according to the embodiments disclosed herein.

The unique patterns are designed to provide a visual indication of the incorrect placement of the wearable ring device (141) within the wireless charging apparatus (101). In FIG. 6A, the unique pattern delivered by the visual indicators is specifically designed to indicate the wrong placement of the wearable ring device (141) as determined by the proximity sensor (115) of the wireless charging apparatus (101).

To achieve this, the unique patterns are programmed to respond to the signals received from the microcontroller (127) of the wireless charging apparatus (101). The proximity sensor (115) is designed to detect the presence of the wearable ring device (141) within the wireless charging apparatus (101) and send signals to the unique patterns to indicate the correct or incorrect placement of the ring. The unique patterns are configured to provide a clear and easy-to-understand visual indication of the correct or incorrect placement of the wearable ring device (141) within the wireless charging apparatus (101).

In FIG. 6B, the unique patterns indicate that no LEDs are glowing when the position of the wearable ring device (141) is corrected within the wireless charging apparatus (101). This is achieved by programming the unique patterns to respond to the signals received from the proximity sensor (115) of the wireless charging apparatus (101) when the wearable ring device (141) is correctly placed within the wireless charging case (101). The unique patterns are designed to provide a clear and easy-to-understand visual indication that the wearable ring device (141) is correctly placed within the wireless charging apparatus (101).

Unlike the conventional charging apparatus, the unique patterns are an important aspect of the technology disclosed herein as they provide a simple and effective way to indicate the correct or incorrect placement of the wearable ring device (141) within the wireless charging apparatus (101). The unique patterns are designed to be easily visible and understandable, making it easy for users to correct any incorrect placement of the wearable ring device (141) within the wireless charging apparatus (101).

FIG. 7A-FIG. 7C is a schematic figure that illustrates unique patterns for indicating wakeup alarm of the wireless charging apparatus, according to the embodiments disclosed herein.

The wireless charging apparatus (101) comprises a plurality of visual indictors (109) that are arranged in a unique pattern for indicating the wake-up alarm. The indication is provided in the visually preamble region (701) in the external surface of the base assembly. The visually permeable region (701) is made of a transparent or semi-transparent material. The unique pattern is designed to glow from the maximum intensity to the lower intensity, which is visually appealing and easily recognizable by the user. The wireless charging apparatus (101) receives the wake-up alarm time from the mobile device or wearable ring device (141) and delivers the unique pattern accordingly.

In an embodiment, the wake-up alarm can be dynamically determined by the mobile device or wearable ring device (141) based on the sleep stages of the user. The mobile device or wearable ring device (141) comprises a sleep monitoring module that monitors the sleep stages of the user and determines the optimal wake-up time. The sleep monitoring module uses various sensors such as an accelerometer, gyroscope, and heart rate monitor to detect the sleep stages of the user. Based on the sleep stages, the sleep monitoring module calculates the optimal wake-up time and sends it to the wireless charging apparatus (101).

The dynamically determined wake-up time or statically set wake-up time is sent to the wireless charging apparatus (101) that can be used by the visual indicators to glow in the unique pattern. The wireless charging apparatus (101) comprises a microcontroller (127) that receives the wake-up time from the mobile device or wearable ring device (141) and controls the visual indicators (109) to glow in the unique pattern. The microcontroller (127) uses a timer to synchronize the unique pattern with the wake-up time. The unique pattern starts glowing from the maximum intensity and gradually decreases in intensity until it reaches the lower intensity, indicating the wake-up alarm.

The wireless charging apparatus (101) delivers the unique pattern for the wake-up alarm based on the time set by the user in the mobile device for waking-up the user. The user can set the wake-up time in the mobile device or wearable ring device (141) using a user interface. The user interface allows the user to set the wake-up time, select the unique pattern, and customize the intensity of the visual indicators. The wireless charging apparatus (101) receives the wake-up time and unique pattern from the mobile device or wearable ring device (141) and delivers the unique pattern accordingly. The user can also customize the unique pattern and intensity using the mobile device or wearable ring device (141).

FIG. 8A-FIG. 8C is a schematic figure that illustrates unique patterns for indicating wind down alert of the wireless charging apparatus, according to the embodiments disclosed herein.

The wind down alert is an alert that is provided to the user when it's time to wind down for sleep. The indication is provided in the visually preamble region (701) in the external surface of the base assembly. In one embodiment, the unique patterns may include a unique sequence of colors that change from green to yellow to red, indicating the level of battery charge remaining in the wireless charging case. Additionally, the unique patterns may include a flashing sequence that indicates the charging status of the wireless charging apparatus (101).

In a further embodiment, the unique patterns may be customizable by the user, allowing them to choose their preferred color and flashing sequence for indicating the charging status and battery level of the wireless charging apparatus (101). This customization may be achieved through a mobile application that communicates with the wireless charging apparatus (101), allowing the user to select their preferred unique patterns and save them for future use.

FIG. 9A-FIG. 9C is a schematic figure that illustrates a sixth unique pattern for indicating breathing sessions for the user using the wireless charging apparatus, according to the embodiments disclosed herein.

The unique patterns are designed to provide visual feedback to the user during the breathing exercises. FIG. 9A illustrates a unique pattern for LEDs glowing to guide the user to perform the breathe-in action. The unique pattern for the breathe-in action is designed to be visually distinct from the other unique patterns to help the user differentiate between the different breathing actions.

FIG. 9B illustrates a unique pattern for visual indicators glowing to guide the user to perform the breath hold action. The unique pattern for the breath hold action is designed to be visually distinct from the other unique patterns to help the user differentiate between the different breathing actions. The unique pattern for the breath hold action is also designed to be longer than the unique pattern for the breathe-in action to indicate to the user that they should hold their breath for a longer period of time.

FIG. 9C is a unique pattern for visual indicators glowing to guide the user to perform the breathe out action. The unique pattern for the breathe out action is designed to be visually distinct from the other unique patterns to help the user differentiate between the different breathing actions. The unique pattern for the breathe out action is also designed to be shorter than the unique pattern for the breathe-in action to indicate to the user that they should exhale for a shorter period of time. Additionally, the unique pattern for the breathe out action is designed to be visually different from the unique pattern for the breath hold action to help the user differentiate between the two actions.

FIG. 10A-FIG. 10C is a schematic figure that illustrates seventh unique patterns for indicating Bluetooth pairing status between the wireless charging apparatus and the wearable ring device, according to the embodiments disclosed herein. In FIG. 10A, the unique pattern for visual indicators glowing during progress of Bluetooth pairing between the mobile device and the wireless charging apparatus (101) is achieved by using a combination of white and blue LEDs. The white LED blinks while the blue LED glows continuously. In FIG. 10B, the unique pattern for LEDs glowing when the Bluetooth connection is successful between the mobile device and the wireless charging apparatus (101) is achieved by using green LEDs. The green LED glows continuously. In FIG. 10C, the unique pattern for visual indicators glowing when the Bluetooth connection is not successful between the mobile device and the wireless charging apparatus (101) is achieved by using a red LED. The red LED blinks continuously.

FIG. 11 is a circuit diagram that illustrates a microcontroller for controlling the functions of wireless charging apparatus to charge the wearable ring device, according to the embodiments disclosed herein.

Further, the microcontroller (127) is connected to the user interface element (119) through first connection. For example, the first connection can include, but not limited to the SW-1 connection. The microcontroller (127) determines the input from the user to perform various operations based on the defined period of time for which the user interface element (119) was held by the user. Further, the microcontroller (127) is connected to the proximity sensor (115) through the second connection. For example, the second connection can include but not limited to a Serial Clock Line (SCL) and Serial Data Line (SDA) connections. The SCL connection is used to provide the clock signals for synchronizing communication between the microcontroller (127) and the proximity sensor (115). The clock signal is generated by the microcontroller (127) and it coordinates when the data is sent and read ensuring both the devices are synchronized during data exchange. The SDA connection is used to transfer data between the microcontroller (127) and the proximity sensor (115). It is a bidirectional line, meaning that both the microcontroller (127) and proximity sensor (115) can send and receive data on this line. Data transfer is synchronized with the clock signal provided on the SCL line. The microcontroller (127) determines whether the wearable ring device (141) is placed within the wireless charging case (101) based on the input signals received from the proximity sensor (115).

Also, the microcontroller (127) is connected to the hall effect sensor (111) through third connection. For example, the third connection can include, but not limited to a HALL-OUT connection. The microcontroller (127) determines whether the wireless charging is closed or opened based on the input 20 signals received from the hall effect sensor (111).

Further, the microcontroller (127) is connected to the charging controller (131) through the fourth connection. For example, the fourth connection can include, but not limited to a PTX Master In Slave Out (PTXMISO), PTX Master Out Slave In (PTXMOSI), PTX Serial Clock (PTXSCK), PTX Slave Select (PTXNSS), PTX Interrupt Output (PTXIRO), PTX Sense (PTXSEN). The PTXMISO connection is used in PI communication. It is the data line for the microcontroller (127) to receive data from the PTX130 charging controller (131). The PTXMOSI connection is used in SPI communication. It is the data line for the microcontroller (127) to send data to the PTX130 charging controller (131). The PTXSCK is used in SPI communication. It provides the clock signal generated by the microcontroller (127) to synchronize data transmission with the PTX130 charging controller (131). The PTXNSS connection is used in SPI communication. It is an active low signal used to select the PTX130 charging controller as the active slave device. The PTXIRO connection is used as an interrupt signal from the PTX130 charging controller (131) to the microcontroller (127). It indicates that the charging controller (131) needs attention, such as when a charging event occurs or an error needs to be reported. The PTXSEN connection is used to sense or control certain functions of the PTX130 charging controller (131). It might be used for power enable/disable, sensing the presence of a device, or other control functions specific to the wireless charging process. The microcontroller (127) provides the control signals to the charging controller (131) to enable the charging of the wearable ring device (141), when the wearable ring device (141) is placed within the wireless charging case (101) and when the cover of the wireless charging case (101) is closed.

Further, the microcontroller (127) sends the signals to at least one of the user interface element (109) and audio output device (117) to emit the light or generate a custom sound based on the requested operation by the user. Also, the microcontroller (127) is connected to the LEDs (109) through the fifth connection. For example, the fifth connection can include, but not limited to LED Clock Input (LED-CI) and LED Data Input (LED-DI). The LED-CI is used to provide the clock signal for synchronizing data transfer to the LEDs (109). The clock signal helps in timing the data transmission so that the LEDs (109) can interpret the incoming data correctly. It is typically used in serial communication protocols like SPI or in dedicated LED driver ICs. The LED-DI is used to input the data stream to the LEDs (109). The data contains information on the state (on/off) and possibly the color and brightness of each LED in the chain or matrix. This pin works in conjunction with the clock input (LED-CI) to ensure that the data is properly timed and received by the LEDs. Also, the microcontroller (127) is connected to the audio output device (117) through the sixth connection. For example, the sixth connection can include, but not limited to BZ-1 connection.

Further, the microcontroller (127) of the wireless charging apparatus (101) is integrated with Bluetooth antenna (137). The Bluetooth antenna (137) is connected to the microcontroller (127) through the tenth connection. For example, the tenth connection can include, but not limited to Radio Frequency Voltage Source Substrate (RFVSS) and Radio Frequency 2.4 GHz Input/Output (RFV2G4_IO). The RFVSS pin provides a reference ground for RF circuitry that is essential for maintaining signal integrity 30 and preventing noise and interference in the RF signal path. Also, the RFV2G4_IO pin is used for the transmission and reception of RF signals in the 40 2.4 GHz frequency band, which is a standard frequency range for Bluetooth communication. Also, the microcontroller (127) gets a 3.3V signal from the power management controller (135) through the eleventh connection.

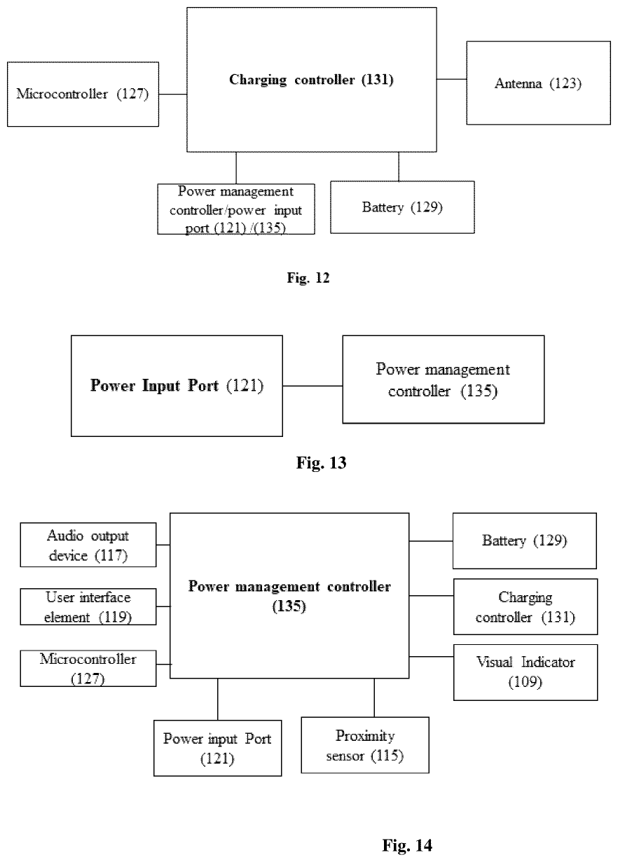

FIG. 12 is a circuit diagram that illustrates a charging controller to charge the wireless charging apparatus and the wearable ring device, according to the embodiments disclosed herein.

The charging controller (131) is connected to the microcontroller (127) through the fourth connections. The charging controller (131) receives the input signals from the microcontroller (127) to enable the charging of the wearable ring device (141). In an embodiment, the charging controller (131) gets voltage supply from battery (129) through seventh connection. For example, the seventh connection is VBAT connection if any LIVE USB C cable is not connected to the wireless charging apparatus (101). Also, the charging controller (131) will get the voltage supply from the (121) the power management controller (135) or the battery (129) through eighth connection. For example, the eighth connection can include, but not limited to the Voltage Digital Power Analog (VDPA) and Voltage Bus Power Transmit (VB-PTX) connections. The VDPA supplies a stable, regulated voltage for the digital and analog circuits of the PTX130 Charging controller (131), ensuring proper operation of its internal components. The VB-PTX provides the main power input for the PTX130 Charging controller (131), especially for its power transmission functions, derived directly from the USB C power bus.

Further, the charging controller (131) is connected to the matching circuit through ninth connection. For example, the ninth connection can include, but not limited to Receive Positive (RXP), Transmit Positive (TXP), Transmit Negative (TXN), Receive Negative (RXN) connections. The RXP is a part of the differential pair for receiving signals. The “P” stands for the positive (or non-inverted) signal in the differential pair. It is used to receive incoming data or signals from the matching circuit. The TXP is part of the differential pair for transmitting signals. The “P” stands for the positive (or non-inverted) signal in the differential pair. It is used to send outgoing data or signals to the matching circuit. The TXN is a part of the differential pair for transmitting signals. The “N” stands for the negative (or inverted) signal in the differential pair. It complements the TXP signal and is used to send outgoing data or signals to the matching circuit, providing better noise immunity. The RXN is part of the differential pair for receiving signals. The “N” stands for the negative (or inverted) signal in the differential pair. It complements the RXP signal and is used to receive incoming data or signals from the matching circuit, providing better noise immunity. The matching circuit is further connected to the antenna (123) to induce the electromagnetic fields for performing the NFC charging of the wearable ring device (141).

FIG. 13 is a circuit diagram that illustrates a power input port for charging the wireless charging apparatus through the external power supply, according to the embodiments disclosed herein. The power input port (121) comprises two parts, that is a first part of charging and a second part of power input port. For the first part of the power input port (121) VBUS and GND-IN act as positive and negative terminals. Similarly, for the second part of the power input port (121) takes the VBUS as the input from the first part. Also, the second part of the power input port (121) gives out VIN 1 as the output port. Further, the output of the second part of the power input port (121) is connected to the power management controller (135) through the twelfth connection. For example, twelfth connection is VIN connection. The power input port (121) provides the voltage supply to the power management controller (135) to divide the supplied voltages between the charging controller (131) and the battery (129) of the wireless charging apparatus (101).

FIG. 14 is a circuit diagram that illustrates a power management controller that controls the power supply to the wireless charging apparatus and the wearable ring device from the external charging port, according to the embodiments disclosed herein. The power management controller (135) takes the voltage supply as the input from the power input port (121) through twelfth connection. Further, the power management controller (135) provides the output to the battery (129) of the wireless charging apparatus (101) through thirteenth connection. For example, the thirteenth connection can be a VBAT connection. Also, the power management controller (135) sends the output signals to the visual indicators (109) through fourteenth connection. For example, the fourteenth connection is VLED connection to glow the visual indicators (109) based on desired operation requested by the user. Also, the power management controller (135) sends a 3.3V voltage supply to the microcontroller (127), the audio output device (117) and the proximity sensor (115). Further, the power management controller (135) sends the output signals to the charging controller (131) through the eighth connection. For example, eighth connection is Voltage Output Buck Converter (VO_BUCK) connection. The VO_BUCK represents the output voltage from a buck converter circuit in the power management controller (135). A buck converter is a type of DC-DC converter that steps down voltage from a higher level to a lower level. In this context, VO_BUCK is likely a stable and regulated voltage level that is suitable for powering the Charging controller (135) and, subsequently, the antenna through the matching circuit. The power management controller (135) sends the signals to the charging controller (131) to charge the wearable ring device (141) placed within the wireless charging apparatus (101).

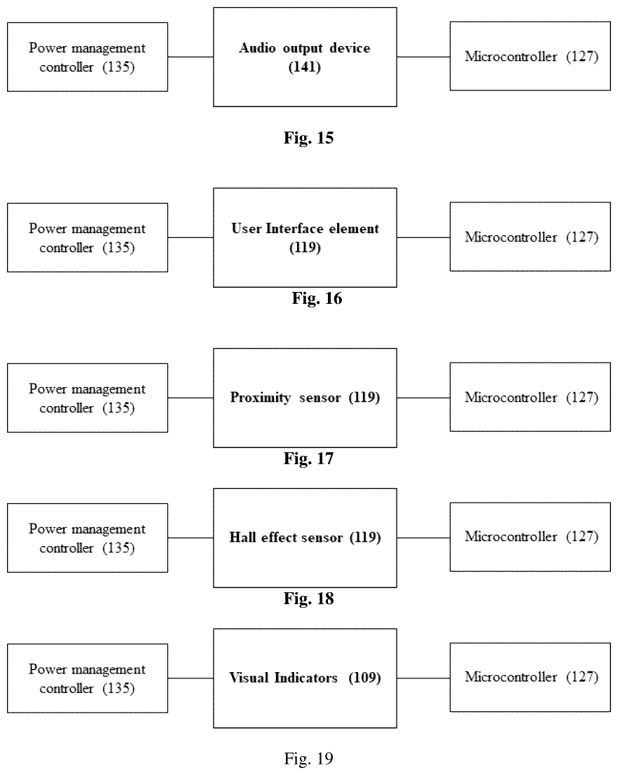

FIG. 15 is a circuit diagram that illustrates an audio output device that provides the custom sounds based on the input signal, according to the embodiments disclosed herein.

The audio output device (117) is connected to the microcontroller (127) through the sixth connection. Additionally, the audio output device (117) takes 3.3V from the power management controller (135). The audio output device (117) receives input signals from the microcontroller (127) to perform the desired operations requested by the user. For example, the audio output device (117) can play a custom sound for 0.5 seconds when the battery of the wireless charging apparatus is low. Similarly, the audio output device (117) plays a custom sound for about 0.25 seconds to indicate the wake-up alarm for the users. Also, the audio output device plays a sound for about 0.25 seconds to provide a notification about the start/end of wind-down time, start/end of timer, start/end of guided breathing sessions. Additionally, the audio output device plays a sound for about 0.5 seconds to provide a wrong ring positioning alert. The audio output device (117) also plays a custom sound that can be customized by the user, including the message to be played that is recorded using the user's voice for a particular operation. For example, the customized sound can be a sound in the user's voice playing “if lost, return to the case,” and the like.

FIG. 16 is a circuit diagram that illustrates a user interface element that can be used by the user to provide the input for performing operations by the wireless charging apparatus, according to the embodiments disclosed herein.

The user interface element (119) is connected to the microcontrollers (127) through the first connection. Additionally, the user interface element (119) takes 3.3V from the power management controller (135). The user interface element (119) sends signals to the microcontroller (127) to initiate the desired operation. The user interface element (119) is designed to be durable and responsive to ensure that the user can easily interact with the device. The one or more operations are performed by the wireless charging apparatus (101) when the user interface element (119) is pressed for defined period of time. For example, when the user interface element (119) is pressed continuously for 15 seconds, then the wireless charging apparatus (101) is reset.

In another embodiment, when the user interface element (119) is pressed or held for 3 seconds, then at least one of a default operation set by the user is performed or stops the timer operation or guided operation if it is running or does not perform any operation. Similarly, when multiple pushes of the user interface element (119) are made by the user, then only the latest button press is considered. In another embodiment, when the user interface element (119) is pressed for less than 0.5 seconds, then the charging levels of the wearable ring device (141) or the wireless charging apparatus (101) can be displayed over the visual indicators (109).

FIG. 17 is a circuit diagram that illustrates a proximity sensor to detect whether the wearable ring device is placed within the wireless charging apparatus, according to the embodiments disclosed herein.

The proximity sensor (119) is connected to the microcontroller (127) through the second connection. Additionally, the proximity sensor (115) receives input from the power management controller (135) through the fifteenth connection. For example, the fifteenth connection can be P1 port. The proximity sensor (115) also receives a 3.3V supply from the power management controller (135). The proximity sensor (115) sends input signals through the second connections to the microcontroller (127) regarding whether the wearable ring device (141) is placed within the wireless charging case (101) or not.

FIG. 18 is a circuit diagram that illustrates a hall effect sensor to detect the opening or closing of the wireless charging apparatus, according to the embodiments disclosed herein. The Hall effect sensor (111) is connected to the microcontroller (127) through the third connection. Additionally, the Hall effect sensor (111) receives 3.3V from the power management controller (135). The Hall effect sensor (111) determines the opening and closing of the cover of the wireless charging apparatus (101) and sends the corresponding signal to the microcontroller (127).

FIG. 19 is a circuit diagram that illustrates a visual indicator providing unique patterns to indicate the charging levels of the wireless charging apparatus and the wearable ring device, according to the embodiments disclosed herein. The visual indicators (109) are connected to the microcontroller (127) through the fifth connection. Additionally, the visual indicators (109) take voltage supply from the power management controller (135) through the VLED connection. The visual indicators (109) receive input signals from the microcontroller to emit light in unique patterns based on the operations requested by the user through the user interface element (119). The different patterns of visual indicators for different operations are shown in FIG. 4-9.

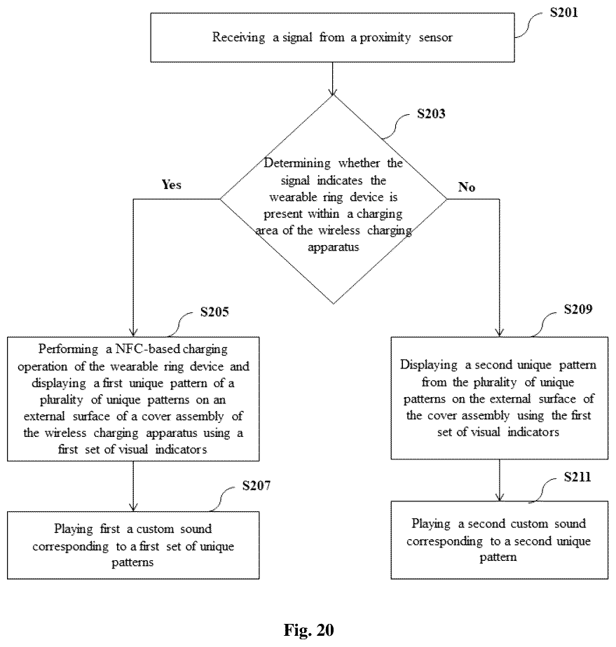

FIG. 20 is a flow diagram that illustrates a method for charging a wearable ring device using a wireless charging apparatus, according to the embodiments disclosed herein.

At block 201, the method includes receiving, by the wireless charging apparatus (101), a signal from a proximity sensor (115). The signal indicates whether the wearable ring device (141) is placed within the charging area (113) of the wireless charging apparatus (101).

At block 203, the method includes determining, by the wireless charging apparatus (101), whether the signal indicates the wearable ring device ( ) is present within a charging area of the wireless charging apparatus.

At block 205, the method includes performing, by the wireless charging apparatus (101), the NFC-based charging operation of the wearable ring device (141) and displaying a first unique pattern of the plurality of unique patterns on an external surface of a cover assembly (103) of the wireless charging apparatus (101) using a first set of visual indicators, when the signal indicates that the wearable ring device is present within the charging area.

At block 207, the method includes playing a first custom sound corresponding to a first set of unique patterns. The first unique pattern indicates variations in charging status of the wearable ring device (141).

At block 209, the method includes displaying a second unique pattern from the plurality of unique patterns using the first set of visual indicators, when the signal indicates that the wearable ring device is not present within the charging area.

At block 211, the method includes playing a second custom sound corresponding to a second unique pattern. The second unique pattern indicates variations in the charging status of the wireless charging apparatus.

The various actions, acts, blocks, steps, or the like in the method are performed in the order presented, in a different order, or simultaneously. Furthermore, in some embodiments, some of the actions, acts, blocks, steps, or the like are omitted, added, modified, skipped, or the like without departing from the scope of the proposed method.

The foregoing description of the specific embodiments will fully reveal the general nature of the embodiments herein such that others can readily modify and/or adapt such specific embodiments for various applications without departing from the generic concept. Therefore, such adaptations and modifications are intended to be comprehended within the meaning and range of equivalents of the disclosed embodiments. It is to be understood that the phraseology or terminology employed herein is for the purpose of description and not of limitation. Thus, while the embodiments herein have been described in terms of preferred embodiments, those skilled in the art will recognize that the embodiments herein can be practiced with modifications within the scope of the embodiments as described herein.

What is claimed is:

1. A wireless charging apparatus (101) for charging a wearable ring device (141) (141), comprises:
a cover assembly (103); and
a base assembly (105) connected to the cover assembly (103), wherein the base assembly (105) comprises:
a first set of visual indicators (109) to display plurality of unique patterns;
a charging area (113) provided in an internal region of the base assembly (105) in which the wearable ring device (141) is placed for charging;
a proximity sensor (115) configured to detect a presence of the wearable ring device (141) within the charging area (113); and
a microcontroller (127) connected to the first set of visual indicators (109), wherein the microcontroller (127) receives a signal indicating whether the wearable ring device (141) is present within the charging area (113) from the proximity sensor (115) and perform one of:
when the signal indicates that the wearable ring device (141) is present within the charging area (113), perform a NFC-based charging operation of the wearable ring device (141), displaying a first unique pattern of a plurality of unique patterns using the first set of visual indicators (109) and playing a first custom sound corresponding to the first unique patterns, wherein the first unique pattern indicates variations in a charging status of the wearable ring device (141), and
when the signal indicates that the wearable ring device (141) is not present within the charging area (113), displaying a second unique pattern from the plurality of unique patterns using the first set of visual indicators (109) and playing a second custom sound corresponding to the second unique pattern, wherein the second unique pattern indicates variations in a charging status of the wireless charging apparatus (101).

2. The wireless charging apparatus (101) as claimed in claim 1, wherein the external surface of the base assembly (103) comprises:
a first visual area displaying the first unique pattern indicating the variations in charging status of the wearable ring device (141), and
a second visual area displaying the second unique pattern indicating the variations in charging status of the wireless charging apparatus (101).

3. The wireless charging apparatus (101) as claimed in claim 2, wherein the first set of visual indicators (109) comprises light-emitting elements arranged in the first visual area in a circular or semicircular configuration to form the variations in the charging status of the wearable ring device (141), and wherein the second visual area is in proximity to the first visual area.

4. The wireless charging apparatus (101) as claimed in claim 1, wherein each unique pattern of the plurality of unique patterns are programmed to change at least one of colour, blink, and animate in various sequences to convey the variations in the charging status of at least one of the wearable ring device (141) and the wireless charging apparatus (101).

5. The wireless charging apparatus (101) as claimed in claim 1, wherein the base assembly (105) comprises:
a visually permeable region provided in an external surface of the base assembly (105);
a second set of visual indicators (109) embedded in the visually permeable region provided in the external surface of the base assembly (105), wherein the second set of visual indicators (109) are configured to visually display a third unique patterns to a user of the wireless charging apparatus (101) and play a third custom sound corresponding to the third unique pattern; and
wherein the microcontroller (127) is connected to the second set of visual indicators (109), and wherein the microcontroller (127) is configured to determine whether an application configuration is met, and displaying a fourth unique pattern from the plurality of unique patterns on the visually permeable region of the base assembly (105) using second set of visual indicators (109) and playing a fourth custom sound corresponding to the fourth unique pattern, wherein the fourth unique pattern indicates a status of the application configuration to the user.

6. The wireless charging apparatus (101) as claimed in claim 5, wherein the second set of visual indicators (109) comprises light-emitting elements arranged at periphery of the visually permeable region of the base assembly (105).

7. The wireless charging apparatus (101) as claimed in claim 5, wherein the visually permeable region is made of a transparent or semi-transparent material.

8. The wireless charging apparatus (101) as claimed in claim 5, wherein the application configuration corresponds to at least one of an alarm application, a wind down application, an activation of a “Find my” function in an associated mobile device to locate the wireless charging apparatus (101), and an activation of a lost mode in the associated mobile device to prevent the wireless charging apparatus (101) from connecting to any other device when misplaced.

9. The wireless charging apparatus (101) as claimed in claim 1, wherein the microcontroller (127) is configured to:
receive the signal from the proximity sensor (115), when the wearable ring device (141) is worn on a finger of a user;
determine whether the wearable ring device (141) is positioned correctly in the charging area (113) of the wireless charging apparatus (101); and
display a fifth unique pattern from the plurality of unique patterns using the first set of visual indicators (109) and playing a fifth custom sound corresponding to the fifth unique pattern, wherein the fifth unique pattern indicates a placement status of the wearable ring device (141) in the charging area (113) of the wireless charging apparatus (101) based on the determination.

10. The wireless charging apparatus (101) as claimed in claim 1, comprises:
a hall effect sensor configured to detect opening and closing of the cover assembly (103) and sends a signal about opening and closing of the cover assembly (103) to the microcontroller (127);
a user interface element (119) to receive input from user to perform one or more operations when an input is received from the user for a defined period of time;
an audio output device (117) configured to play custom sound based on the one or more operations performed by the wireless charging apparatus (101);
a power input port (121) configured to receive voltage signals from external power supply to charge the wireless charging apparatus (101);
an antenna (123) configured to generate an electromagnetic field that is used to charge the wearable ring device (141) and induce current within the antenna (123) of the wearable ring device (141), and charge the wearable ring device (141) through the antenna (123) of the wearable ring device (141);
a power management controller (135) configured to supply power to the battery (129), the charging controller (131), visual indicators (109), proximity sensor (115) and the hall effect sensor;
a charging controller (131) configured to charge the wearable ring device (141) when the wearable ring device (141) is placed within the charging area (113);
a battery (129) configured to supply power to the charging controller (131) for charging wearable ring device (141); and
a memory (133) configured to store information about at least one of the opening and closing of the cover assembly (103), whether the wearable ring device (141) is placed within the charging area (113), the plurality of unique patterns, and application configurations.

11. The wireless charging apparatus (101) as claimed in claim 10, wherein the microcontroller (127) is configured to:
receive an input from the user on the user interface element (119) for the defined period of time;
activate a breathing mode within the wireless charging apparatus (101) based on the input received from the user for the defined period of the time;
display a sixth unique pattern from the plurality of unique patterns using the first set of visual indicators (109) when the wireless charging apparatus (101) is in the breathing mode and play a sixth custom sound corresponding to the sixth unique pattern, wherein the sixth unique pattern indicates at least one of a breathe-in, breathe-out, and breathe-hold cues to the user.

12. The wireless charging apparatus (101) as claimed in claim 1, wherein the microcontroller (127) is configured to:
determine a status of Bluetooth paring process between the wireless charging apparatus (101) and the wearable ring device (141); and
display a seventh unique pattern from the plurality of unique patterns using the first set of visual indicators (109) and playing a seventh custom sound corresponding to the seventh unique pattern, wherein the seventh unique pattern indicates the status of Bluetooth paring process between the wireless charging apparatus (101) and the wearable ring device (141).

13. The wireless charging apparatus (101) as claimed in claim 10, wherein perform the NFC-based charging operation of the wearable ring device (141) comprises:
receive signal by the antenna (123) from the charging controller (131) to charge the wearable ring device (141);
generates an electromagnetic field that induces current within the antenna (123) of the wearable ring device (141) using the charging controller (131); and
performing the NFC-based charging operation of the wearable ring device (141) based on the generated electromagnetic field.

14. The wireless charging apparatus (101) as claimed in claim 10, wherein the microcontroller (127) is configured to:
receive an indication about the input from the user interface element (119) through first connection to perform the one or more operations;
receive an indication of the correct placement or incorrect placement of the wearable ring device (141) within the charging area (113) from the proximity sensor (115) through second connections;
receive an indication of the opening or closing of the cover assembly (103) from the hall effect sensor through third connection;
receive input voltage from the power management controller (135) to control the operations of the wireless charging apparatus (101);
send the control signals to the charging controller (131) through fourth connection to charge the wearable ring device (141), when the indication of the correct placement of the wearable ring device (141) within the charging area (113) is received from the proximity sensor (115);
sends control signals to the visual indicators (109) through fifth connection to emit the light in a unique patterns based on the inputs received from the user interface element (119); and
send the control signals to the audio output device (117) through sixth connection to play a custom sound corresponding to a unique pattern based on the inputs received from the user interface element (119).

15. The wireless charging apparatus (101) as claimed in claim 10, wherein the charging controller (131) is configured to:
receive control signals from the microcontroller (127) through fourth connection to enable the charging of the wearable ring device (141);
receive input voltage from the at least one power management controller (135) or battery (129) to perform charging of the wearable ring device (141), wherein the charging controller (131) is connected to the battery (129) through seventh connection and to the power management controller (135) to the eighth connection; and
performs charging of the wearable ring device (141) using the antenna (123) through the matching circuit, wherein the charging controller (131) is connected to the matching circuit using ninth connection.

16. The wireless charging apparatus (101) as claimed in claim 1, wherein the cover assembly (103) and the base assembly (105) is made of at least one of a metallic material, non-metallic material and semi-metallic material.

17. A method for charging a wearable ring device (141) using a wireless charging apparatus (101), the method comprising:
receiving, by a wireless charging apparatus (101), a signal from a proximity sensor (115);
determining, by the wireless charging apparatus (101), whether the signal indicates the wearable ring device (141) is present within a charging area (113) of the wireless charging apparatus (101); and
performing, by the wireless charging apparatus (101), one of:
when the signal indicates that the wearable ring device (141) is present within the charging area (113), performing a NFC-based charging operation of the wearable ring device (141) and displaying a first unique pattern of a plurality of unique patterns on an external surface of a cover assembly (103) of the wireless charging apparatus (101) using a first set of visual indicators (109) and playing first a custom sound corresponding to a first set of unique patterns, wherein the first unique pattern indicates variations in charging status of the wearable ring device (141), and
when the signal indicates that the wearable ring device (141) is not present within the charging area (113), displaying a second unique pattern from the plurality of unique patterns using the first set of visual indicators (109) and playing a second custom sound corresponding to a second unique pattern, wherein the second unique pattern indicates variations in the charging status of the wireless charging apparatus (101).

18. The method of claim 17, comprising:
displaying, by the wireless charging apparatus (101), the first unique pattern indicating the variations in charging status of the wearable ring device (141) in a first visual area of the external surface; and
displaying, by the wireless charging apparatus (101), the second unique pattern indicating the variations in charging status of the wireless charging apparatus (101) in a second visual area of the external surface.

19. The method of claim 17, comprising:
configuring, by the wireless charging apparatus (101), a second set of visual indicators (109) to visually display a third unique patterns to the user of the wireless charging apparatus (101) and playing a third custom sound corresponding to the third unique pattern;
determining, by the wireless charging apparatus (101), whether an application configuration is met; and
displaying, by the wireless charging apparatus (101), a fourth unique pattern from the plurality of unique patterns on a visually permeable region of a base assembly (105) using the second set of visual indicators (109) and playing a fourth custom sound corresponding to the fourth unique pattern, wherein the fourth unique pattern indicates a status of the application configuration to the user.

20. The method of claim 17, comprising:
receiving, by the wireless charging apparatus (101), the signal from the proximity sensor (115) when the wearable ring device (141) is worn on a finger of a user;
determining, by the wireless charging apparatus (101), whether the wearable ring device (141) is positioned correctly in the charging area (113) of the wireless charging apparatus (101); and
displaying, by the wireless charging apparatus (101), a fifth unique pattern from the plurality of unique patterns using the first set of visual indicators (109) and playing a fifth custom sound corresponding to the fifth unique pattern, wherein the fifth unique pattern indicates a placement status of the wearable ring device (141) in the charging area (113) of the wireless charging apparatus (101).

21. The method of claim 17, further comprising:
receiving, by the wireless charging apparatus (101), an input from the user interface element (119) for a defined period of time;
activate a breathing mode within the wireless charging apparatus (101) based on the input received from the user for the defined period of the time displaying, by the wireless charging apparatus (101), a sixth unique pattern from the plurality of unique patterns using the first set of visual indicators (109) when the wireless charging apparatus (101) is in the breathing mode and playing a sixth custom sound corresponding to the sixth unique pattern, wherein the sixth unique pattern indicates breathe in, breathe out and breathe hold cues to the user.

22. The method of claim 17, comprising:
determining, by the wireless charging apparatus (101), a status of Bluetooth pairing process between the wireless charging apparatus (101) and the wearable ring device (141); and
displaying, by the wireless charging apparatus (101), a seventh unique pattern from the plurality of unique patterns using the first set of visual indicators (109) and playing a seventh custom sound corresponding to the seventh unique pattern, wherein the seventh unique pattern indicates the status of Bluetooth pairing process between the wireless charging apparatus (101) and the wearable ring device (141).

23. The method of claim 17, comprising:
detecting, by the wireless charging apparatus (101), opening and closing of the cover assembly (103), and sending a signal about the opening and closing of the cover assembly (103);
receiving, by the wireless charging apparatus (101), an input for a defined period of time from a user through a user interface element (119) to perform one or more operations;
playing, by the wireless charging apparatus (101), a custom sound using through an audio output device (117) based on the one or more operations performed by the wireless charging apparatus (101);
receiving, by the wireless charging apparatus (101), voltage signals from an external power supply through a power input port (121) to charge the wireless charging apparatus (101);
generating, by the wireless charging apparatus (101), an electromagnetic field using an antenna (123) to charge the wearable ring device (141) and induce current within the antenna (123) of the wearable ring device (141);
supplying, by the wireless charging apparatus (101), power to a battery (129), a charging controller (131), visual indicators (109), proximity sensor (115) and hall effect sensor;
supplying, by the wireless charging apparatus (101), power to a charging controller (131) using a battery (129) for charging the wearable ring device (141);
charging, by the wireless charging apparatus (101), the wearable ring device (141) using the charging controller (131) when the wearable ring device (141) is placed within the charging area (113); and
storing, by the wireless charging apparatus (101), information about at least one of the opening and closing of the cover assembly (103), whether the wearable ring device (141) is placed within the charging area (113), the plurality of unique patterns, and application configurations in a memory (133).
